(19) United States
(12) Patent Application Publication
(10) Pub. No.: US 2025/0264397 A1
(43) Pub. Date: Aug. 21, 2025

(54) Light-field Flow Cytometer

(71) Applicant: Georgia Tech Research Corporation, Atlanta, GA (US)

(72) Inventors: Shu Jia, Atlanta, GA (US); Keyi Han, Atlanta, GA (US); Xuanwen Hua, Atlanta, GA (US)

(21) Appl. No.: 19/051,991

(22) Filed: Feb. 12, 2025

Related U.S. Application Data
(60) Provisional application No. 63/554,542, filed on Feb. 16, 2024.

(51) Int. Cl. G01N 15/1434; G01N 15/14; G01N 21/64

(52) U.S. Cl. CPC G01N 15/1434; G01N 15/147; G01N 15/1484; G01N 21/6428; G01N 21/6458; G01N 2021/6439

(57) ABSTRACT

An exemplary three-dimensional (3D) imaging light-field flow cytometry system and method are disclosed, that can provide 3D volumetric, high-throughput, and multiparametric analysis of single-cell populations. In an example system, the system is configured to provide high-content, single-shot, and multi-color acquisition of >5,000 cells per second with a near-diffraction-limited resolution of 400-600 nm in all three dimensions.

### RELATED APPLICATION

This U.S. application claims priority to, and the benefit of, U.S. Provisional Patent Application No. 63/554,542, filed Feb. 16, 2024, entitled “Light-field Flow Cytometer,” which is incorporated by reference herein in its entirety.

### GOVERNMENT LICENSED RIGHTS

This invention was made with government support under R35GM124846, awarded by the National Institutes of Health. The government has certain rights in the invention.

### BACKGROUND

Flow cytometry is an analytical method to measure the physical and chemical characteristics of cells or particles in a fluid as they pass through a laser beam, providing information about cell size, complexity, and the presence of markers on the cell surface but not subcellular information of the cells. Cells may be labeled with fluorescent markers to emit light at different wavelengths when excited by the laser, enabling the identification and quantification of various cell populations. Flow cytometry is often used in research and clinical settings for immunophenotyping, cell sorting, and diagnosing diseases like leukemia and lymphoma.

There is a benefit to improving the flow cytometry systems.

### SUMMARY

An exemplary three-dimensional (3D) imaging light-field flow cytometry system and method are disclosed that can provide 3D volumetric, high-throughput, and multiparametric analysis of single-cell populations. In an example system, the system is configured to provide high-content, single-shot, and multi-color acquisition of >5,000 cells per second with a near-diffraction-limited resolution of 400-600 nm in all three dimensions.

In some implementations, the exemplary system can incorporate a high-resolution light-field optofluidic platform, hydrodynamic focusing, and stroboscopic illumination, offering a near-diffraction-limited and multi-color resolution of various 3D subcellular morphologies across all three dimensions at high speeds. The exemplary system can examine and quantify a range of phantoms and biological morphologies, functions, and heterogeneities, including peroxisomes and mitochondria in cultured cells, morphological characterizations of isolated cells, apoptotic alterations in staurosporine-treated cells, and the expression of tdTomato following Cre mRNA delivery.

Compared to other 3D techniques, the exemplary system and method can provide single-shot, scanning-free 3D acquisition and instrumentally simple operation on epi-fluorescence platforms, both desirable features for cytometric imaging. Employing an accessible and compatible cytometric imaging method, the exemplary system and method can advance cell biology and translational research, and therapeutic developments, among others.

In an aspect, a system for capturing cytometric images of a plurality of cells or particles in a moving fluidic sample is disclosed comprising a cytometric microfluidic chip having one or more channels, including a first channel (i.e., main channel) for flow and imaging of the plurality of cells or particles; one or more laser sources, including a first laser device configured to project a laser beam of the first laser device on the fluidic sample; an optical assembly optically connected to the one or more laser sources, the optical assembly being configured to (i) emit the laser beam on the fluidic sample, (ii) receive fluorescence rays emitted from the fluidic sample in response to the fluidic sample being projected with the emitted laser beam, and (iii) generate wide-field and light-field images of the fluidic sample from the received fluorescence rays; a microlens array coupled to the optical assembly, the microlens array having a plurality of microlens elements configured to partition the wide-field and light-field images into a plurality of elemental images, each having a high field of view and depth of focus; and a sensor (e.g., camera) configured to capture the plurality of the elemental images at a back focal plane of the microlens array, wherein the plurality of elemental images are used, via a reconstruction algorithm, to generate a 3D cytometric high-resolution, wide-field image or video of the plurality of cells or particles concurrently captured in a single view and at different depths (e.g., and at multicolor).

In some embodiments, the system described herein further comprises a stroboscopic-illumination controlling module (SICM) coupled between the one or more laser sources and the optical assembly, the SICM being configured to modulate the laser beam; and project the modulated laser beam on the fluidic sample to excite the plurality of cells or particles (e.g., to minimize motion blur in the reconstruction).

In some embodiments, the one or more channels further includes two secondary channels.

In some embodiments, the first channel contains the fluidic sample, and the two secondary channels contain a salt solution (e.g., for hydrodynamic focusing), wherein the salt solution in the two secondary channels is injected into the fluidic sample in the first channel to facilitate focused-flowing of the fluidic sample within the field of view of the system.

In some embodiments, the one or more laser sources further include a second laser device, and the system further comprises a second optical assembly to combine (i) the first laser beam and (ii) a second laser beam from the second laser device to generate the laser beam to be emitted through the optical assembly.

In some embodiments, the microlens elements of the microlens array are formed in the microlens array in a flat configuration.

In some embodiments, the system described herein further comprises an image processing unit having a processor and a memory having instructions stored thereon to generate the 3D cytometric high-resolution, wide-field image or video of the plurality of cells or particles, wherein execution of the instructions by the processor causes the processor to receive the plurality of elemental images (e.g., as a lossless compression, high-color depth and layer images or video frames); remove blank images or images with non-specific fluorescence from the received images (e.g., via a background subtraction operation and other image enhancement processing, e.g., denoising) to generate a set of reconstructable images; remove outside-field-of-view regions from the set of reconstructable images; and reconstruct the set of modified reconstructable images via a hybrid point-spread-function-based deconvolution operation to generate the 3D cytometric high-resolution, wide-field image or video of the plurality of cells or particles.

In some embodiments, the first laser beam and the second laser beam have different wavelengths of different colors.

In some embodiments, the first laser beam and the second laser beam have same wavelengths.

In another aspect, a method is disclosed comprising generating a laser beam from a laser source; capturing cytometric images of a plurality of cells or particles in a moving fluidic sample by providing a cytometric microfluidic chip having one or more channels, including a first channel (i.e., main channel) for flow and imaging of the plurality of cells or particles; emitting the laser beam on the fluidic sample; receiving fluorescence rays emitted from the fluidic sample in response to the fluidic sample being projected with the emitted laser beam; generating wide-field and light-field images of the fluidic sample from the received fluorescence rays; partitioning, via a microlens array, the wide-field and light-field images into a plurality of elemental images, each having a high field of view and depth of focus; capturing, via a sensor (i.e., camera), the plurality of the elemental images at a back focal plane of the microlens array; generating, via a reconstruction algorithm, a 3D cytometric high-resolution, wide-field image or video of the plurality of cells or particles concurrently captured in a single view and at different depths (e.g., and at multicolor) using the plurality of elemental images.

In some embodiments, the method described herein further comprises prior to emitting the laser beam on the fluidic sample, modulating the laser beam using a SICM; and projecting the modulated laser beam on the fluidic sample to excite the plurality of cells or particles (e.g., to minimize motion blur in the reconstruction).

In some embodiments, the method described herein further comprises receiving the plurality of elemental images (e.g., as a lossless compression, high-color depth and layer images or video frames); removing blank images or images with non-specific fluorescence from the received images (e.g., via a background subtraction operation and other image enhancement processing, e.g., denoising) to generate a set of reconstructable images; removing outside-field-of-view regions from the set of reconstructable images; and reconstructing the set of modified reconstructable images via a hybrid point-spread-function-based deconvolution operation to generate the 3D cytometric high-resolution, wide-field image or video of the plurality of cells or particles.

In some embodiments, the one or more channels further includes two secondary channels.

In some embodiments, the first channel contains the fluidic sample and the two secondary channels contain a salt solution (e.g., for hydrodynamic focusing), wherein the salt solution in the two secondary channels is injected into the fluidic sample in the first channel to facilitate focused-flowing of the fluidic sample.

In another aspect, a system for capturing cytometric images of a plurality of cells or particles in a moving fluidic sample is disclosed comprising one or more laser sources, including a first laser device configured to project a laser beam of the first laser device on the fluidic sample, wherein the fluidic sample is contained in a cytometric microfluidic chip having one or more channels, including a first channel for flow and imaging of the plurality of cells or particles; an optical assembly optically connected to the one or more laser sources, the optical assembly being configured to (i) emit the laser beam on the fluidic sample, (ii) receive fluorescence rays emitted from the fluidic sample in response to the fluidic sample being projected with the emitted laser beam, and (iii) generate wide-field and light-field images of the fluidic sample from the received fluorescence rays; a microlens array coupled to the optical assembly, the microlens array having a plurality of microlens elements configured to partition the wide-field and light-field images into a plurality of elemental images, each having a high field of view and depth of focus; and a sensor (e.g., camera) configured to capture the plurality of the elemental images at a back focal plane of the microlens array, wherein the plurality of elemental images are used, via a reconstruction algorithm, to generate a 3D cytometric high-resolution, wide-field image or video of the plurality of cells or particles concurrently captured in a single view and at different depths (e.g., and at multicolor).

In some embodiments, the system described herein further comprises a stroboscopic-illumination controlling module (SICM) coupled between the one or more laser sources and the optical assembly, the SICM being configured to modulate the laser beam; and project the modulated laser beam on the fluidic sample to excite the plurality of cells or particles (e.g., to minimize motion blur in the reconstruction).

In some embodiments, the one or more channels further includes two secondary channels.

In some embodiments, the first channel contains the fluidic sample and the two secondary channels contain a salt solution (e.g., for hydrodynamic focusing), wherein the salt solution in the two secondary channels is injected into the fluidic sample in the first channel to facilitate focused-flowing of the fluidic sample within field of view of the system.

In another aspect, a non-transitory computer-readable medium is disclosed having instructions stored thereon to generate a 3D cytometric high-resolution, wide-field image or video of a plurality of cells or particles from a plurality of elemental images of the plurality of cells obtained from a microlens array, wherein execution of the instructions by a processor causes the processor to receive the plurality of elemental images (e.g., as a lossless compression, high-color depth and layer images or video frames); remove blank images or images with non-specific fluorescence from the received images (e.g., via a background subtraction operation and other image enhancement processing, e.g., denoising) to generate a set of reconstructable images; remove outside-field-of-view regions from the set of reconstructable images; and reconstruct the set of modified reconstructable images via a hybrid point-spread-function-based deconvolution operation to generate the 3D cytometric high-resolution, wide-field image or video of the plurality of cells or particles.

### BRIEF DESCRIPTION OF DRAWINGS

FIGS. 1A-1B each shows an example system (i.e., example light-field cytometric (LFC) system) configured with a cytometric microfluidic chip and a light-field microscope in accordance with an illustrative embodiment. In the examples shown in FIGS. 1A-1B, the light-field microscope can comprise one or more laser sources, a first optical assembly, a microlens array, a sensor, and an image processing unit. FIG. 1B further employs a second optical assembly and a stroboscopic-illumination controlling module (SICM) in the light-field microscope.

FIGS. 2A-2B show example operation flows for capturing cytometric images of a plurality of cells or particles in a moving fluidic sample shows an example operation flow for the exemplary system and reconstructing a 3D cytometric high-resolution, wide-field image or video from elemental images of a plurality of cells or particles in a moving fluidic sample, in accordance with an illustrative embodiment. FIG. 2A shows an example operation flow of the exemplary system for capturing cytometric images of a plurality of cells or particles in a moving fluidic sample. FIG. 2B shows an example operation flow of the exemplary system for reconstructing a 3D cytometric high-resolution, wide-field image or video from elemental images of a plurality of cells or particles in a moving fluidic sample.

FIG. 3 shows an example cytometric microfluidic chip comprising a main channel and two side channels.

FIGS. 4A-4B show a fabricated light-field microscope coupled with the cytometric microfluidic chip in the exemplary system.

FIG. 4C shows a microlens array (MLA) employed in the exemplary system and the elemental images it can generate.

FIG. 4D shows the stroboscopic illumination method used for the cytometric image acquisition of the stroboscopic-illumination controlling module (SICM).

FIG. 4E shows the image processing flowchart (also shown in FIG. 2B) of the exemplary system.

FIG. 4F shows the point spread function (PSF) calibration process in the exemplary system.

FIG. 4G compares the performance of the image reconstruction process with and without radiality analysis.

FIG. 4H shows the implementation of a deep-learning model in image reconstruction for the exemplary system.

FIGS. 5A-5J show the evaluations of the exemplary system in imaging cells or particles in a moving fluidic sample. FIG. 5A shows the characterization of the exemplary system using fluorescent microspheres. FIG. 5B shows the exemplary system employing virtual-scanning light-field microscopy (VsLFM) and hyper light-field microscopy (HyLFM) methods. FIG. 5C shows the cell throughput estimation in the exemplary system. FIG. 5D shows the analytical throughput of the exemplary system and conventional wide-field cytometry as a function of objective magnification (e.g., 10×, 15×, 20×, 40×, 100×). FIG. 5E shows the imaging results of peroxisomes and mitochondria in flowing HeLa cells with the exemplary system. FIG. 5F shows the comparative analysis of cell morphologies in isolated mouse and human cells. FIG. 5G shows the morphological changes in Staurosporine (STS)-treated Jurkat cells visualized through the exemplary system. FIG. 5H shows the detection of Cre mRNA expression with lipid nanoparticle (LNP)-delivery in isolated mouse cells. FIG. 5I shows the higher throughput imaging with the Jurkat cell nucleus. FIG. 5J shows the image quality of different noise and motion-blur levels and the effects of using ACsN method.

### DETAILED DESCRIPTION

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the list. For example, [1] refers to the first reference in the list. All references cited and discussed in this specification are incorporated herein by reference in their entirety and to the same extent as if each reference was individually incorporated by reference.

### Example System

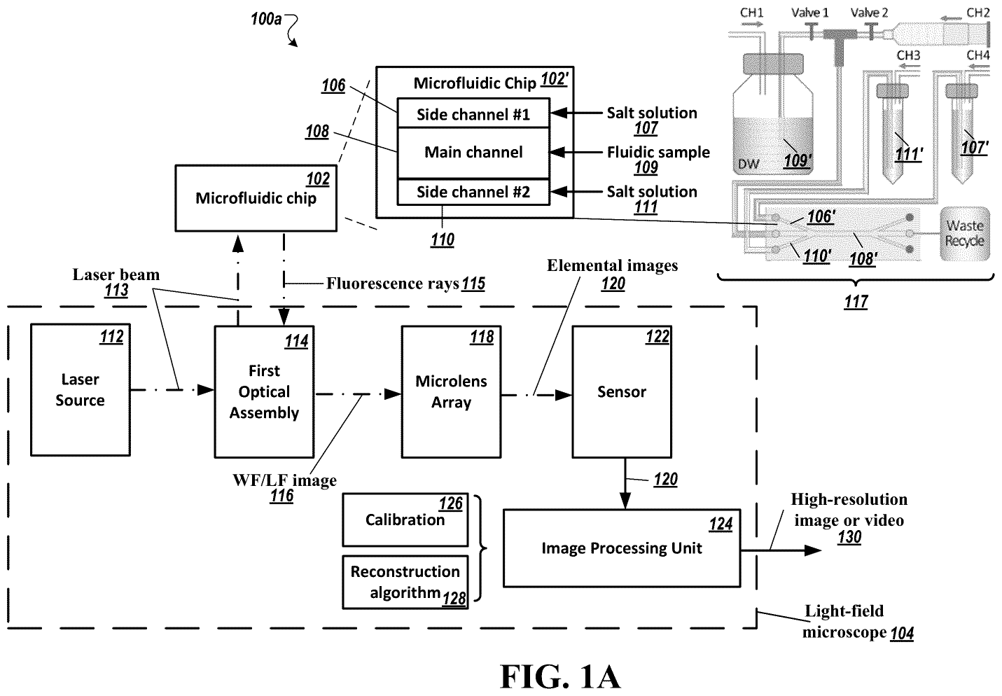

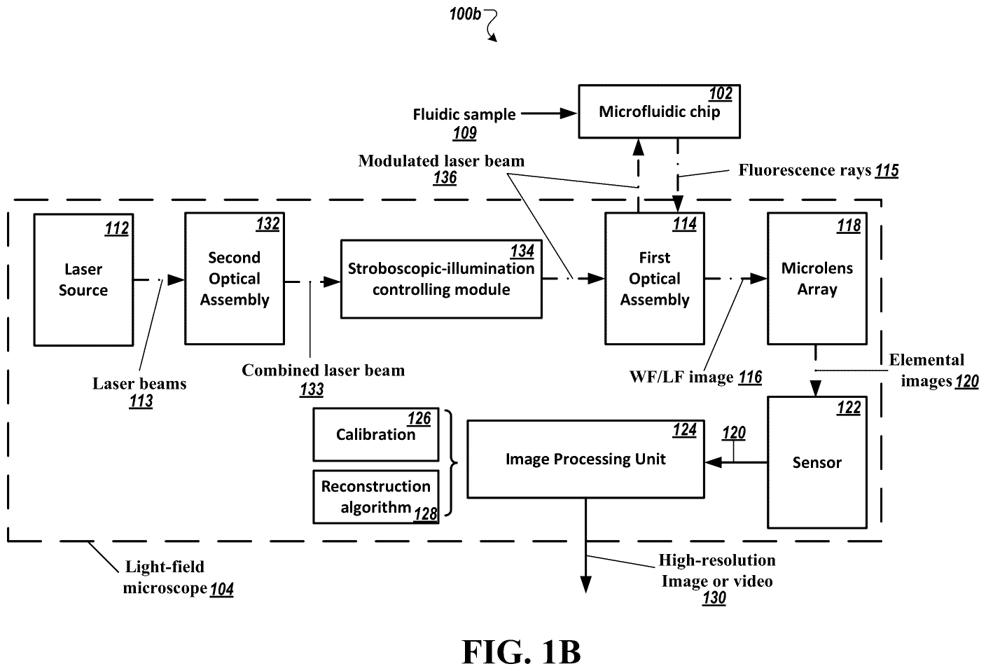

FIGS. 1A-1B each shows an example system 100 (shown as 100a, 100b) configured with a cytometric microfluidic chip 102 (shown as 102′) and a light-field microscope 104. In the examples shown in FIGS. 1A-1B, the light-field microscope 100a, 100b comprise one or more laser sources 112, a first optical assembly 114, a microlens array 118, a sensor 122, and an image processing unit 124. FIG. 1B further employs a second optical assembly 132 and a stroboscopic-illumination controlling module 134 (SICM) in the light-field microscope 104.

Cytometric microfluidic chip (i.e., cytometer portion). In the example shown in FIGS. 1A-1B, the cytometric microfluidic chip 102 (shown as 102′), coupled to the first optical assembly 114, has one or more channels, including a first channel 108 (shown as the main channel, 108′) for flow and imaging of a plurality of cells or particles in a fluidic sample 109 (shown as 109′). The channels can further include two secondary channels 106 (shown as side channel #1, 106′) and 110 (shown as side channel #2, 110′).

The main channel 108 contains the fluidic sample 109, and the two secondary channels 106 and 110 each contain salt solution 107 (shown as 107′) and 111 (shown as 111′) (e.g., for hydrodynamic focusing). The two secondary channels 106 and 110 are configured to inject the salt solution 107 and 111 into the fluidic sample 109 in the main channel 108 to facilitate focused-flowing of the fluidic sample 109.

The main channel 108 and the secondary channels 106 and 110 can receive the fluidic sample (e.g., 109) and salt solution (e.g., 107, 111), via tubes or syringes (shown as channels, CH), from a flow controller system 117 comprising (i) a plurality of valves (e.g., valve 1, valve 2) and (ii) a plurality of containers (e.g., tanks, reservoirs) for fluidic sample 109′ and salt solution 107′ and 111′. The flow controller system 117 is configured to (i) open Valve 1 and Valve 2 to pump the fluidic sample 109′ into the main channel 108′ through CH2 tube, (ii) pump the salt solution 107′ into the side channel 106 via CH4 tube, and (iii) pump the salt solution 111′ into the side channel 109 via CH3 tube. In some embodiments, the main channel 108′ is coupled to a recycle waste tank to contain the excessive fluidic sample.

Light-field microscope. In the light-field microscope 104 shown in FIG. 1A, the laser source 112, including a first laser device, is configured to project a laser beam 113 of the first laser device on the fluidic sample 109. In the light-field microscope 104 shown in FIGS. 1A-1B, the first optical assembly 114 (optically connected to the laser source 112 in FIG. 1A, or coupled to the SICM in FIG. 1B) is configured to (i) emit the laser beam 113 (FIG. 1A) or the modulated laser beam 136 (FIG. 1B) on the fluidic sample 109 (contained in the microfluidic chip 102), (ii) receive fluorescence rays 115 emitted from the fluidic sample 109 in response to the fluidic sample 109 being projected with the emitted laser beam 113 or modulated laser beam 136, and (iii) generate wide-field and light-field images 116 (shown as WF/LF images) of the fluidic sample 109 from the received fluorescence rays 115.

The microlens array 118, coupled to the first optical assembly 114, can partition the WF/LF images 116 into a plurality of elemental images 120, wherein each element image 120 has a high field of view and depth of focus. The microlens elements of the microlens array 118 are formed in the microlens array in a flat configuration.

The sensor 122 (e.g., camera), coupled with the microlens array 118, is configured to capture the plurality of the elemental images 120 at a back focal plane of the microlens array 118. The plurality of elemental images can then be used via a reconstruction algorithm to generate a 3D cytometric high-resolution, wide-field image or video of the plurality of cells or particles concurrently captured in a single view and at different depths (e.g., and at multicolor) (shown as high-resolution image or video 130).

The image processing unit 124, coupled with the sensor 122, can perform a point-spread-function (PSF)-based calibration operation 126 before receiving the plurality of elemental images 120 (e.g., as lossless compression, high-color depth, and layer images or video frames) to perform better image reconstruction. Then, the image processing unit removes blank images or images with non-specific fluorescence from the received elemental images 120 (e.g., via a background subtraction operation and other image enhancement processing, e.g., denoising) to generate a set of reconstructable images. The image processing unit 124 then (i) removes outside-field-of-view regions from the set of reconstructable images and (ii) reconstructs the set of modified reconstructable images via hybrid PSF-based deconvolution operation to generate the high-resolution image or video 130.

In the light-field microscope 104 shown in FIG. 1B, the laser source 112 includes a second laser device emitting a second laser beam. The first laser beam and the second laser beam can have (i) different wavelengths of different colors or (ii) the same wavelengths. The second optical assembly 132, optically connected to the laser source 112, is configured to combine (i) the first laser beam and (ii) the second laser beam to generate a combined laser beam 133.

Stroboscopic-illumination. Still in FIG. 1B, the stroboscopic-illumination controlling module 134 (SICM), coupled between the laser source 112 and the first optical assembly 114, is configured to modulate the combined laser beam 133 and project the modulated laser beam 136 on the fluidic sample 109 to excite the plurality of cells or particles (e.g., to minimize motion blur in the image reconstruction). The first optical assembly 114 is configured with a plurality of objective lenses (OL), emission filters (EF), tubelenses (TL), and Fourier lenses (FL). The second optical assembly is configured with a plurality of dichroic mirrors (DM).

### Example Method

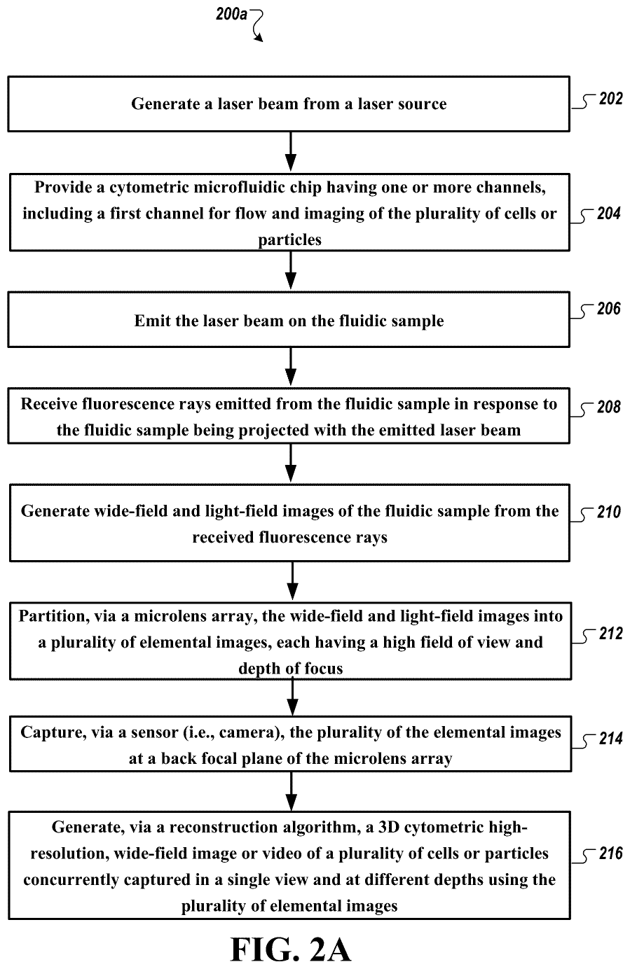

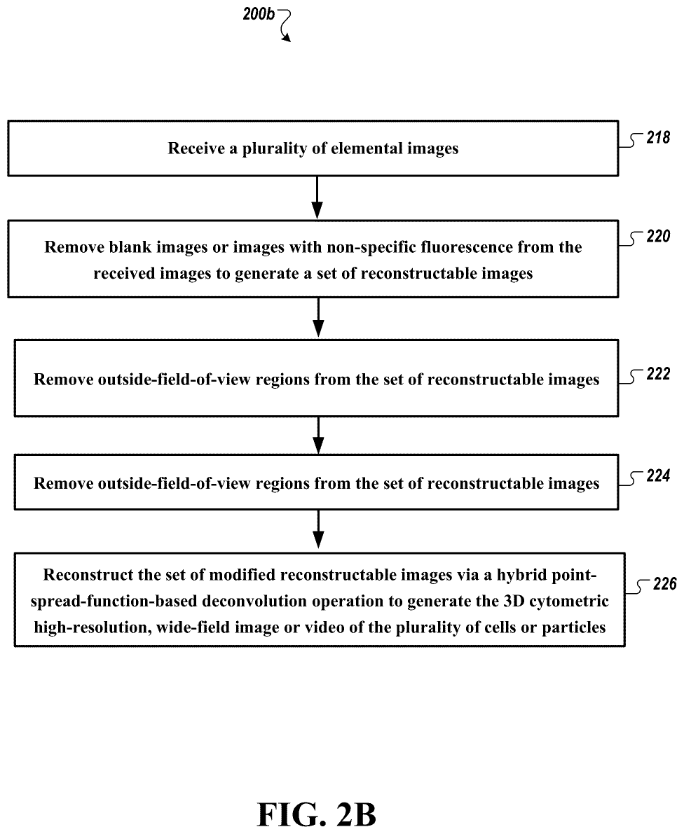

FIG. 2A shows an example operation flow 200a of the exemplary system for capturing cytometric images of a plurality of cells or particles in a moving fluidic sample, which can comprise 8 steps. At step 202, the exemplary system can generate a laser beam from a laser source. At step 204, the exemplary system can provide a cytometric microfluidic chip having one or more channels, including a first channel for flow and imaging of the plurality of cells or particles. At step 206, the exemplary system can emit the laser beam on the fluidic sample. At step 208, the exemplary system can receive fluorescence rays emitted from the fluidic sample in response to the fluidic sample being projected with the emitted laser beam. At step 210, the exemplary system can generate wide-field and light-field images of the fluidic sample from the received fluorescence rays. At step 212, the exemplary system can partition, via a microlens array, the wide-field and light-field images into a plurality of elemental images, each having a high field of view and depth of focus. At step 214, the exemplary system can capture, via a sensor (i.e., camera), the plurality of the elemental images at a back focal plane of the microlens array. At step 216, the exemplary system can generate, via a reconstruction algorithm, a 3D cytometric high-resolution, wide-field image or video of a plurality of cells or particles concurrently captured in a single view and at different depths using the plurality of elemental images.

FIG. 2B shows an example operation flow 200b of the exemplary system for reconstructing a 3D cytometric high-resolution, wide-field image or video from elemental images of a plurality of cells or particles in a moving fluidic sample, which can comprise 5 steps. At step 218, the exemplary system can receive a plurality of elemental images. At step 220, the exemplary system can remove blank images or images with non-specific fluorescence from the received images to generate a set of reconstructable images. At step 222, the exemplary system can remove outside-field-of-view regions from the set of reconstructable images. At step 224, the exemplary system can remove outside-field-of-view regions from the set of reconstructable images. At step 226, the exemplary system can reconstruct the set of modified reconstructable images via a hybrid point-spread-function-based deconvolution operation to generate the 3D cytometric high-resolution, wide-field image or video of the plurality of cells or particles.

Stroboscopic illumination setup. The system may employ stroboscopic illumination operation to shorten the illumination period within a camera exposure period (T_{cam}). The effective camera exposure time (T_{eff}) may be determined by the illumination period, with which cell movements may be constrained to less than half of the theoretical spatial resolution within T_{eff}. Quantitatively, the displacement d of a sample during T_{eff} can be calculated per Equation 1.

$$d = v \times {T}_{eff} \qquad ( Eq . 1 )$$

In Equation 1, v is the flow speed of the sample. To suppress motion blur, the displacement d should be less than the lateral resolution of the exemplary LFC system (e.g., at 400-600 nm).

Vectorial Debye Model and Reconstruction process. The reconstruction operation may be based on a wave function at the native image plane (NIP) in Equation 2 determined using the vectorial Debye theory to address the high numerical aperture (NA) of the objective lens and the corresponding refractive-index mismatch (RIM) between the objective lens immersion medium and the sample solution.

$$( Eq . 2 )$$

$${U}_{i} ( x , p ) = \frac{M}{{f}_{obj}^{2} {λ}^{2}} {\int }_{0}^{α} \sqrt{cos {θ}_{1}} sin {θ}_{1} \times exp [ {ik}_{0} Φ ( l ) + \frac{iu cos ( {θ}_{2} )}{4 {sin}^{2} ( α / 2 )} ] \times \{ ( {τ}_{s} + {τ}_{p} cos ( {θ}_{2} ) {J}_{0} ) [ \frac{sin {θ}_{1}}{sin α} v ] - ( {τ}_{s} - {τ}_{p} cos {θ}_{2} ) {J}_{2} [ \frac{sin {θ}_{1}}{sin α} v ] \} d {θ}_{1}$$

In Equation 2, f_{obj} is the objective focal length. J₀ and J₂ are the zeroth and second-order Bessel functions of the first kind, respectively. v and u represent normalized radial and axial coordinates and are defined by Equations 3 and 4, respectively.

$$v = {{k}_{1} [ {( \frac{{x}_{1}}{M} - {p}_{1} )}^{2} + {( \frac{{x}_{2}}{M} - {p}_{2} )}^{2} ]}^{1 / 2} sin ( α ) \qquad ( Eq . 3 )$$

$$u = 4 {k}_{2} {p}_{3} {sin}^{2} ( α / 2 ) \qquad ( Eq . 4 )$$

In Equations 2, 3, and 4, p=(p₁, p₂, p₃)∈ [symbol] is the point source in the object space; x=(x₁, x₂)∈ [symbol] represents the image position on the NIP. M is the objective magnification; α is determined by the minimum half-angle of NA and the critical angle of total internal reflection, i.e., α=min[sin⁻¹(NA/n₁), sin⁻¹(n₂/n₁)]. The wavenumbers k_{1,2}=2πn_{1,2} \hat{k}_{1,2}/λ may be calculated using emission wavelength λ, refractive index n₁ of the immersion medium, and refractive index n₂ of the sample solution. θ₁ and θ₂ are the refractive (objective side) and incident (sample side) angles at the media interface, respectively.

In Equation 2, the aberration function @ (l), the Fresnel transmission coefficients τₛ and τₚ may be defined per Equations 5, 6, and 7.

$$Φ ( l ) = - l ( {n}_{1} cos {θ}_{1} - 2 cos {θ}_{2} ) \qquad ( Eq . 5 )$$

$${τ}_{s} = \frac{2 sin {θ}_{2} cos {θ}_{1}}{sin ( {θ}_{1} + {θ}_{2} )} \qquad ( Eq . 6 )$$

$${τ}_{p} = \frac{2 sin {θ}_{2} cos {θ}_{1}}{sin ( {θ}_{1} + {θ}_{2} ) cos ( {θ}_{1} - {θ}_{2} )} \qquad ( Eq . 7 )$$

In Equations 5, 6, and 7, l is the normal focusing position (NFP). In the imaging system, the refractive index of the immersion oil may have a value n₁=1.515, and n₂ is 1.33 for the PBS solution, as an example. The refractive index may be adjusted for other solution and oils or solutions. The reconstruction system may employ an azimuthal angle of the emitter in the polar coordinates φₚ=90° since the fluorescence from the emitters exhibited an isotropic polarization so that the light field only pointed to the p₁ direction.

Next, the image at the NIP Uᵢ(x, p) may be optically Fourier transformed onto the back focal plane of the Fourier lens, described as O [symbol] T[Uᵢ(x, p)], which may then be modulated by the MLA. The modulation may be described by a transmission function ϕ(x′), where x′=(x₁′, x₂′)∈ [symbol] represents the coordinates on the MLA. In some embodiments, e.g., where the microlens aperture is a hexagonal amplitude mask hex (x′/d), combined with a phase mask, the aperture may be expressed as

$$exp ( \frac{- ik}{2 {f}_{ML}} {‖ {x}^{′} ‖}_{2}^{2} ) ,$$

where K=2π/λ is the wavenumber in the air. The modulation induced by a microlens may then be defined per Equation 8.

$$ϕ ( {x}^{′} ) = hex ( \frac{{x}^{′}}{d} ) exp ( \frac{- ik}{2 {f}_{ML}} ) {‖ {x}^{′} ‖}_{2}^{2} \qquad ( Eq . 8 )$$

The entire modulation may be described by the convolution of ϕ(x′) with a comb function comb_{Δ}(x′/d) that corresponded to the three microlenses, i.e., Φ(x′)=ϕ(x′), where ⊗ represents the convolution operator.

The light field propagation from the MLA to the camera may be modeled using the Fresnel propagation over a distance of f_{ML} per Equation 9.

$$h ( {x}^{″} , p ) = {ℱ}^{- 1} \{ ℱ [ 0 ℱ T [ {U}_{i} ( x , p ) ] Φ ( {x}^{′} ) ] \times exp [ i 2 π \sqrt{{f}_{M L} {( \frac{1}{λ} )}^{2} - ( {f}_{x}^{2} + {f}_{y}^{2} )} ] \} \qquad ( Eq . 9 )$$

In Equation 9, x″=(x₁″, x₂″)∈ [symbol] represents the positions on the camera plane. The exponential term is the Fresnel transfer function. fₓ and f_{y} are the spatial frequencies in the camera plane. [symbol] and [symbol] represent the Fourier transform and inverse Fourier transform, respectively. In practice, the Fresnel propagation over distance f_{ML} may be calculated in small steps for computational accuracy. The final intensity image O(x″) at the camera plane containing elemental images of each microlens may be defined per Equation 10.

$$O ( {x}^{″} ) = \int {\vert h ( {x}^{″} , p ) ‖}^{2} g ( p ) dp \qquad ( Eq . 10 )$$

In Equation 10, g(p) is the intensity distribution of the volume of isotropic emitters in the object space.

As shown in Equation 10, the intensity image at the camera image may be described as O=HG, where the measurement matrix H was determined by the PSF. The elements h_{j,k}, in H represent the light projection from the k-th volume g^{(k)} in the object space to the pixel O(j) on the camera plane. The reconstruction may be performed as an inverse problem of retrieving the radiant intensity at each point of the 3D object volume with the camera image O, which may be derived per Equation 11.

$${g}^{( k + 1 )} = diag [ diag {( {H}^{T} H {g}^{( k )} )}^{- 1} ( {H}^{T} O ) ] {g}^{( k )} \qquad ( Eq . 11 )$$

In Equation 11, the operator diag diagonalizes a matrix. This expression may be a modified deconvolution algorithm based on the Richardson-Lucy iteration scheme. In an example system, the sampling pixel sizes for reconstruction may be set as Δ_{xy}=153 nm and Δ_{z}=100 nm. For visualization, the system may interpolate pixels (e.g., 2×2×2 pixels) into each reconstructed pixel to match the camera pixel size.

The 3D deconvolution may iteratively perform forward projection (Hg^{(k)}) and back projection (H^{T} O and H^{T} Hg^{(k)}) between the 3D object space and the 2D camera plane. The spatially invariant 3D PSF PSF(x″, z)=|h(x″, p)|² may be described and numerically derived by an on-axis emitter p=(0, 0, z). As a result, the forward projection may be obtained by summing up the 2D convolutions on each layer within an axial range [z₀, z₁] per Equation 12.

$$H {g}^{( k )} {\sum }_{z = {z}_{0}}^{z = {z}_{1}} P S F ( {x}^{″} , z ) ⊗ {g}^{( k )} ( z ) \qquad ( Eq . 12 )$$

In Equation 12, g^{(k)}(z) represents a single layer located at z in the 3D object volume. Hence, the back projection can be given per Equations 13 and 14.

$$\begin{matrix}[ {H}^{T} O ] ( z ) = {PSF}^{′} ( {x}^{″} , z ) ⊗ O & ( Eq . 13 ) \\ [ {H}^{T} H {g}^{( k )} ] ( z ) = {PSF}^{′} ( {x}^{″} , z ) ⊗ {Hg}^{( k )} & ( Eq . 14 )\end{matrix}$$

In Equations 13 and 14, PSF′(x″, z) was acquired by rotating PSF(x″, z) by 180 degrees.

### Example Cytometric Microfluidic Chip

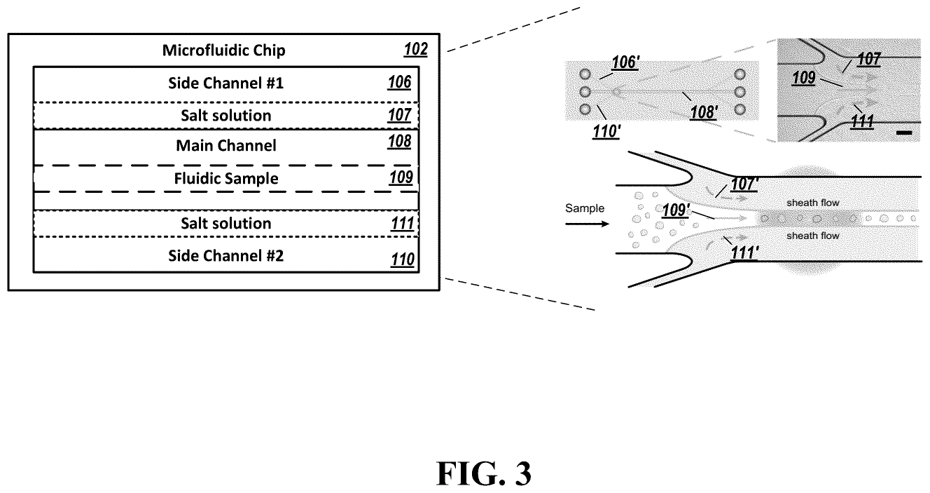

FIG. 3 shows an example cytometric microfluidic chip comprising a main channel 108 (shown as 108′) and two side channels 106 (shown as side channel #1) and 110 (shown as side channel #2). The main channel 108 contains the fluidic sample 109 (shown as 109′), and the two side channels 106 and 110 each contain salt solution 107 (shown as 107′) and 111 (shown as 111′). The two side channels 106 and 110 are configured to inject the salt solution 107 and 111 into the fluidic sample 109 in the main channel 108 to facilitate focused-flowing of the fluidic sample 109. The side channels 106 and 110 can have higher pressure than the main channel so that the salt solutions 107 and 11 can be injected into the main channel 108, creating hydrodynamic focusing for the fluidic sample 109.

### Experimental Results and Additional Examples

A study was conducted to develop and evaluate the exemplary system and method comprising (i) a cytometric microfluidic chip and (ii) a light-field microscope to provide subcellular information of a moving fluidic sample with a high 3D resolution, throughput, sensitivity, and instrumental simplicity.

### Experiment Procedure

Samples. The study prepared a plurality of samples to evaluate the exemplary light-field cytometry (LFC) system. Table 1 shows a list of experimental samples and materials used in the evaluations.

TABLE 1

| Name | Brand | Category ID |
|---|---|---|
| 200 nm fluorescent beads | Thermo Fisher Scientific | T7280 |
| 1 μm fluorescent beads | Thermo Fisher Scientific | T7282 |
| 4 μm fluorescent beads | Thermo Fisher Scientific | T7283 |
| 2 μm fluorescent beads | Bangs Laboratories, Inc. | FSFR005, FCSY007, |
| | | FSDG005 |
| Citrate buffer | Teknova | |
| cKK-E12 | Oragnix Inc. | O-8744 |
| C18PEG2K | Avanti Lipids | |
| 18:1 (Δ9-Cis) PE (DOPE) | Avanti Lipids | |
| Microfluidic device | Hamilton Company | |
| for LNP formulation | | |
| Dynamic light scattering | Wyatt | DynaPro Plate Reader II |
| 20 kD dialysis cassette | Thermo Fisher Scientific | |
| NanoDrop | Thermo Fisher Scientific | |
| 1X TE | Thermo Fisher Scientific | |
| Triton X-100 | Fisher BioReagents | BP151-100 |
| RiboGreen reagent | Thermo Fisher Scientific | |
| Plate reader | BioTek | Synergy H4 Hybrid |
| Ai14 mice | Jackson Laboratories | C57BL/6J (B6/000664) |
| Wheat germ agglutinin (WGA) | Thermo Fisher Scientific | W11261 |
| phosphate-buffered saline (PBS) | Corning | 21-040-CM |
| 4% paraformaldehyde (PFA) solution | Thermo Fisher Scientific | FB002 |
| 16% paraformaldehyde (PFA) | Electron Microscopy Sciences | 15710 |
| EDTA | Thermo Fisher Scientific | 15575038 |
| trypsin-EDTA | Thermo Fisher Scientific | 25200056 |
| HeLa cells 93021013 | Sigma-Aldrich | 93021013 |
| Dulbecco's modified Eagle medium | Corning | 10-013-CV |
| (DMEM) | | |
| 10% fetal bovine serum (FBS) | Corning | 35-011-CV |
| 1% Penicillin-Streptomycin | Thermo Fisher Scientific | 15140122 |
| (PenStrep) | | |
| CellLight Peroxisome-GFP | Thermo Fisher Scientific | C10604 |
| MitoTracker Deep Red FM | Thermo Fisher Scientific | M22426 |
| Hank's balanced salt solution (HBSS) | Corning | 21-021-CV |
| Hank's balanced salt solution without | Corning | 21-023-CV |
| Phenol Red | | |
| CD8+ T cell isolation kit | Stemcell Technologies | |
| Rosewell Park Memorial Institute | Thermo Fisher Scientific | 11875101 |
| medium (RPMI) | | |
| FluoroDish | World Precision Instruments | FD35-100 |
| SYTO16 | Thermo Fisher Scientific | S7578 |
| 1.2X HCS CellMask Deep Red | Thermo Fisher Scientific | H32721 |
| Dimethyl sulfoxide (DMSO) | Thermo Fisher Scientific | D12345 |
| Density gradient centrifugation | Lymphoprep | 07801 |
| SepMate-15 mL tube | STEMCELL technologies | 85415 |
| EasySep Human CD3 Positive | STEMCELL technologies | 17851 |
| Selection Kit II | | |
| Dynabeads Human T-Activator | Thermo Fisher Scientific | 11131D |
| X-vivo 10 Serum-free Hematopoietic | Lonza | 04-380Q |
| Cell Medium | | |
| 5% Human AB serum | Valley Biomedical | HP1022 |
| 10 mM N-Acetyl-L-cysteine | Sigma Aldrich | A9165 |
| 55 μM 2-Mercaptoethanol | Sigma Aldrich | M3148-100 ml |
| 50 μ/mL recombinant human IL-2 | TECIN ™ Teceleukin, NCI | Bulk Ro 23-6019 |
| Collagenase Type I | Sigma Aldrich | |
| Collagenase XI | Sigma Aldrich | |
| Hyaluronidase | Sigma Aldrich | |
| anti-CD31 | BioLegend | 390 |
| anti-CD45 | BioLegend | 30-F11 |
| TruStain FcX ™ (anti-mouse | BioLegend | 93 |
| CD16/32) Antibody | | |
| Jurkat T cells | Sigma Aldrich | 88042803 |
| Staurosporine (STS), 99+% | Thermo Scientific | J62837. #0 |
| SYTO deep red | Thermo Fisher Scientific | S34900 |
| 8-well glass-bottom μ-Slide | ibidi USA | 80827 |
| sodium borohydride | Sigma Aldrich | 452882 |
| bovine serum albumin (BSA) | Sigma Aldrich | A7906 |
| TOMM20 Polyclonal Antibody | Thermo Fisher Scientific | PA5-52843 |
| PMP70 Polyclonal Antibody | Thermo Fisher Scientific | MA5-31368 |
| anti-rabbit secondary antibody | Thermo Fisher Scientific | A32723 |
| anti-mouse secondary antibody | Thermo Fisher Scientific | A32733 |
| CD3 antibody (Hit-3a) | Thermo Fisher Scientific | 16-0039-81 |
| L-15 imaging media | Thermo Fisher Scientific | 21-083-027 |

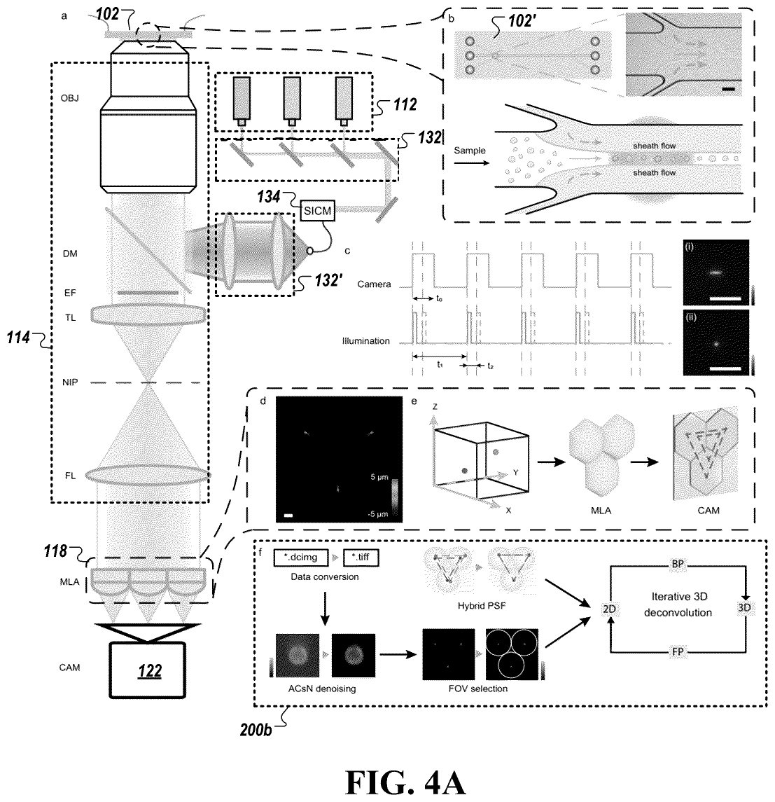

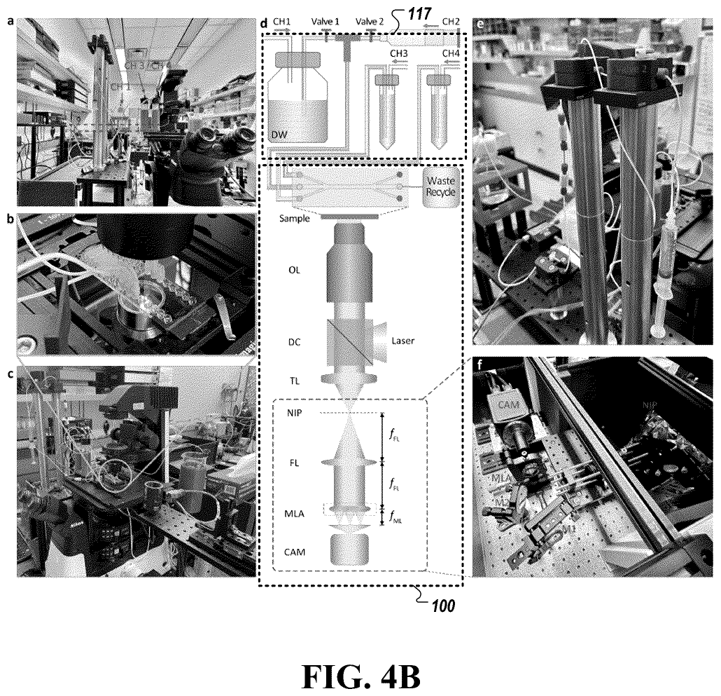

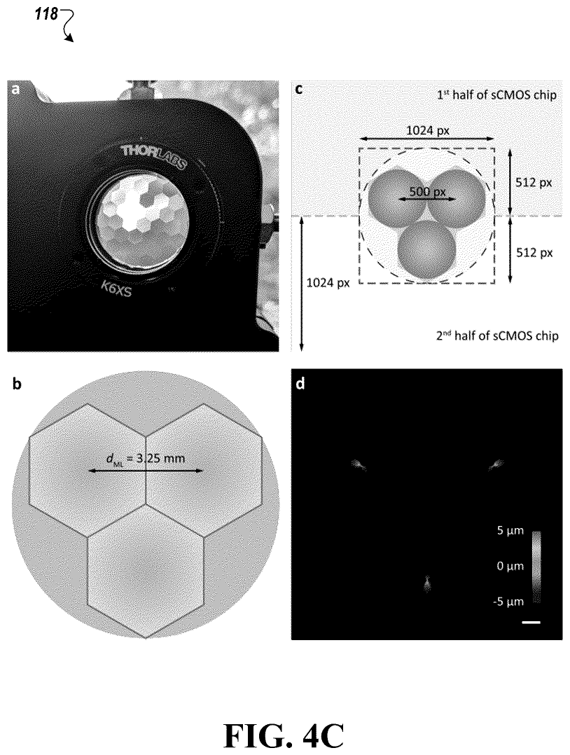

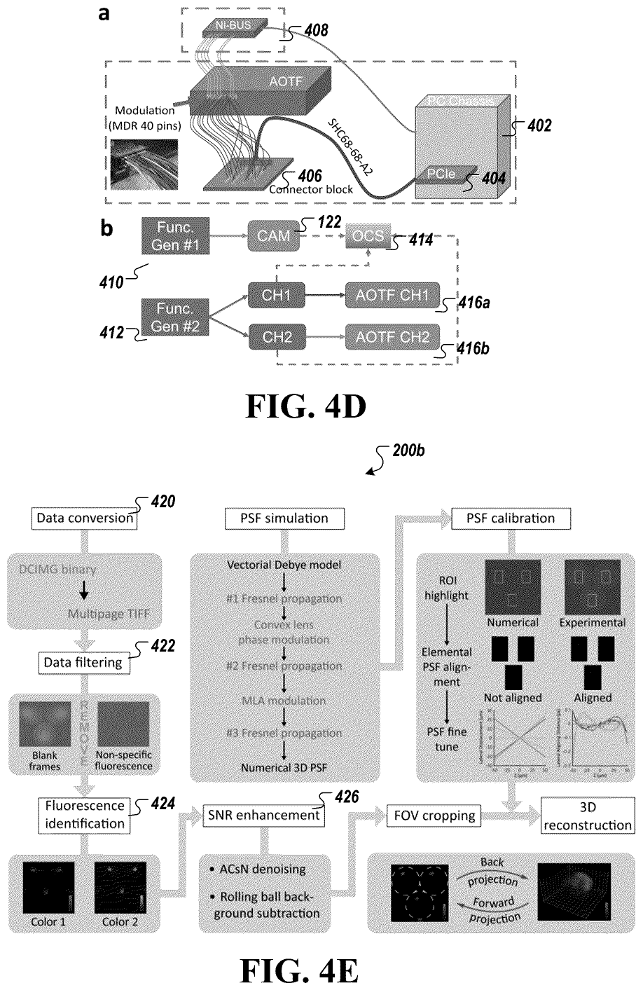

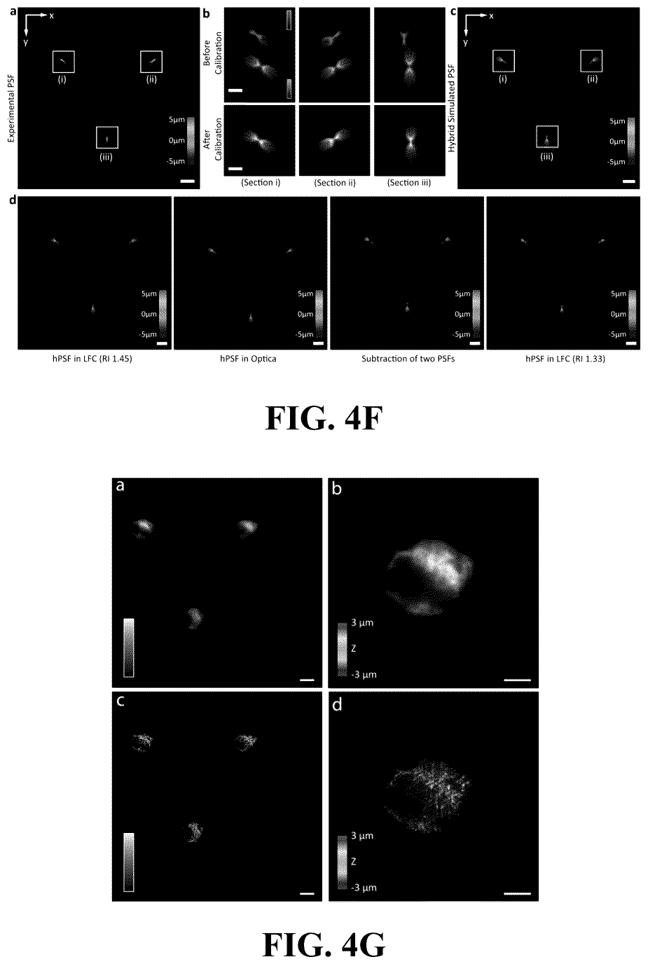

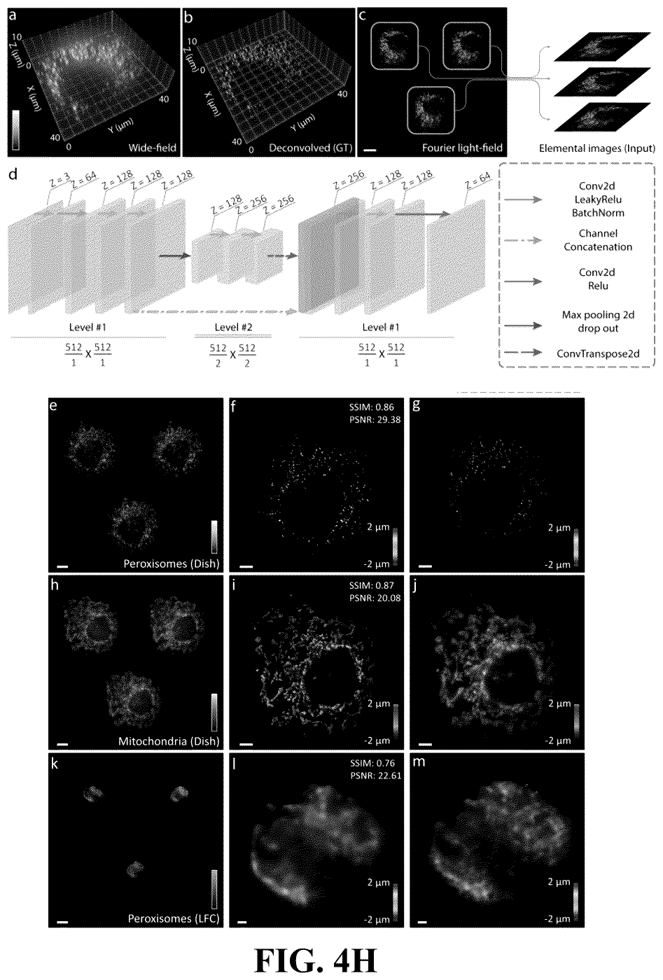

Light-field imaging system. The study developed a high-resolution Fourier light-field microscopy system using an epi-fluorescence microscope (e.g., Eclipse Ti2-U, Nikon Instruments) [43]. FIGS. 4A-4B show the exemplary LFC system 100 (i.e., exemplary system) comprising a high-resolution Fourier light-field microscope (i.e., microscopy system) (shown as 104 in FIGS. 1A-1B) coupled with a cytometric microfluidic chip (shown as 102 in FIGS. 1A-1B).

In FIG. 4A, the exemplary system 100 comprises (i) a laser source 112 having three laser devices with different colors, (ii) a first optical assembly 114 having an objective lens (OBJ), a dichroic mirror (DM), an emission filter (EF), a tubelens (TL), and a Fourier lens (FL), (iii) a second optical assembly 132 (shown as 132′) having a plurality of DMs, (iv) a SICM 134, a microlens array 118 (MLA), and a camera 122 (CAM).

In FIG. 4A, subpanel (a), the employed objective lens was an oil-immersion lens featuring 100× magnification and a numerical aperture (NA) of 1.45 (e.g., CFI Plan Apochromat Lambda 100× Oil, Nikon Instruments). The study utilized a piezo nano-positioner (Nano-F100S, Mad City Labs) for precise positioning. The study excited samples using multicolor laser lines (e.g., 488 nm, 561 nm, 647 nm, MPB Communications), with the fluorescence collected through a quadband dichroic mirror (e.g., ZT405/488/561/647, Chroma) and a corresponding emission filter (ZET405/488/561/647m, Chroma). The sample stage incorporated a micro-positioning system (e.g., MS2000, Applied Scientific Instrumentation) for accurate placement. The native image plane of the objective lens was Fourier-transformed using a Fourier lens (e.g., f_{EL}=275 mm, Edmund Optics). The study placed a customized microlens array (e.g., f_{ML}=117 mm, RPC Photonics) on the back focal plane of the Fourier lens. The study captured elemental images formed by each microlens using an sCMOS camera (e.g., ORCA-Flash 4.0 V3, Hamamatsu Photonics, pixel size P_{cam}=6.5 μm).

FIG. 4A, subpanel (b) shows an exploded view of the cytometric microfluidic chip 102. The microfluidic chip 102 contained (i) a main sample channel (shown as 108 in FIGS. 1A-1B) having a width of 500 μm and a depth of 30 μm and (ii) two side channels (shown as 106, 110 in FIGS. 1A-1B) containing red Hank's balanced salt solution (HBSS). The pressure difference between the side channels and the main channel was adjusted to create a proper hydrodynamic focusing for the HBSS (top inset and bottom) of 70-80 μm in width, agreeing with the field of view of the exemplary system.

FIG. 4A, subpanel (c) shows the stroboscopic illumination of laser lines (generated by the SICM 134) synchronized and controlled within each digital camera exposure to minimize motion blur. Multiple illumination cycles were generated within each global camera exposure to at an interval of t₂. The period of the multi-illumination cycle sets t₁ corresponded to the camera frame rate.

FIG. 4A, subpanel (d) shows axial stack projection (step size=100 nm) of the hybrid point-spread function (hPSF) through the customized MLA 118 within an axial range of 10 μm, as color-coded in the color scale bar.

FIG. 4A, subpanel (e) shows light-field image formation for emitters at different 3D positions, uncompromisingly capturing both spatial and angular information. Subpanel (f) shows the operation flow 200b for reconstructing a 3D cytometric high-resolution, wide-field image or video from elemental images of a plurality of cells or particles in a moving fluidic sample.

In FIG. 4B, subpanel (a) shows a front view of the exemplary LFC system 100, wherein the pump is higher than channels 1, 3, and 4 (shown as CH1, 3, and 4) containers for stable control of microfluidics flow. FIG. 4B, subpanel (b) shows a close view of a microfluidics chip loaded on the microscope with 3D-printed adapters. FIG. 4B, subpanel (c) shows a right view of the exemplary LFC system.

FIG. 4B, subpanel (d) shows a schematic of the exemplary LFC system 100 coupled with a flow controller system 117 comprising (i) a plurality of valves (e.g., valve 1, valve 2) and (ii) a plurality of containers (e.g., tanks, reservoirs) for a fluidic sample and salt solution. In subpanel (d), DW denotes deionized water, OL denotes objective lens, DC denotes dichroic cube, TL denotes tube lens, NIP denotes native image plane, FL denotes Fourier lens, MLA denotes microlens array, CAM denotes camera, f_{FL} denotes focal length of Fourier lens, and f_{ML} denotes focal length of each microlens.

FIG. 4B, subpanel (e) shows a left view of the exemplary LFC system. Subpanel (f) shows a top view of Fourier light-field microscopy, wherein M1 and M2 denote mirrors.

Microlens array design. The Fourier light-field imaging part of the exemplary LFC system is an aperture-partition system, where an MLA was placed to segment the Fourier plane. Such configuration significantly determined the LFM resolution, the field of view (FOV), and the depth of focus (DOF). The MLA was designed to minimize the Fourier aperture segmentation for a sufficient photon budget. By maximizing the FOV and high spatial frequency usage throughout the pupil, the reconstruction quality was secured with an optimum 3D resolution. Hence, the study customized the MLA for subcellular imaging performance according to the optical Vectorial Debye model.

FIG. 4C shows the microlens array employed in the exemplary system. Subpanel (a) shows the photo of the MLA. In subpanel (b), the hexagonal MLA segmented the pupil into three off-axis elements with a pitch size of d_{ML}=3.25 mm, an f-number of 36, and a microlens focal length of f_{ML}=117 mm. In FIG. 4A, subpanel (c), the light field of a single emitter passing through the MLA occupied the central quarter of the camera sensor and formed a point-spread function (PSF) with three elemental images shown in FIG. 4A, subpanel (d). The study omitted the on-axis microlens to reduce segmentation since the on-axis element contained mainly the DC component of the light field with a low angular sensitivity, which contributed less significantly to the overall 3D imaging capability.

Flow cytometer and microfluidic preparation. In FIG. 4B, subpanel (d), the microfluidic setup was constructed with a 3-channel microfluidic flow controller system 117 (e.g., OB1 MK3+, Elveflow) having a microfluidic flow sensor (e.g., MFS3, Elveflow), microfluidic chips (e.g., 10001824, ChipShop), microfluidic reservoirs (e.g., LVF-KPT-M-2, Darwin Microfluidics), a syringe (e.g., BD-PLSTPK-LL-01, Darwin Microfluidics), and a waste tank. Before the experiments, the study filled the reservoirs with deionized water. During the experiments, the study first opened the pump side valve (i.e., Valve 1) while blocking the syringe side valve (i.e., Valve 2) to flush the chip with deionized water from all three channels, cleaning the channels before the measurements. Following the pre-experimental cleaning, the study halted the pump and replaced the solution in the two small reservoirs connected to the side channels of the chip with Hank's balanced salt solution (HBSS). The study then reactivated the pump to establish a stable, focused flow. Upon achieving the flow without bubbles in the channels, the study closed Valve 1 and opened Valve 2. The study injected the samples into the tubes and the chip with a syringe. Once the samples filled the tubes (e.g., 1-2 mL), the study closed Valve 2 and reopened Valve 1, allowing the samples to be automatically and controllably introduced into the chip.

Flow-focusing scheme. In FIGS. 4A-4B, the study conducted the flow-focusing methods following the hydrodynamic focusing principles [3′], [4′]. In the experiments, the study injected the samples into the main sample channel of the microfluidic chip and red HBSS into the two side channels with a microfluidic pump (e.g., OB1 MK4, Elveflow). The study adjusted the pressures in the three channels to control the widths of the sample flow and the sheath fluids so that the sample flow width could be constrained within the field-of-view (FOV) of the imaging system. Before the acquisition, the study set the pressure to 300˜600 mbar for the main sample channel and 600 mbar for each side channel until the study could observe a stable hydrodynamic flow where the three channels were merged. The width of the central branch was ˜80 μm with these pressure configurations. Once the fluids were stabilized, the study decreased the pump pressures proportionally to reduce the cell speed. For imaging with 100 μs exposure time, the study set the pressure of the central channel to 12˜18 mbar and side channels to 24 mbar. For imaging with 5 μs exposure time, the study put the pressure of the central channel to ˜400 mbar and side channels to ˜600 mbar.

Cytometric image acquisition. After loading the samples into the microfluidic system, the study initially employed the epi-fluorescence port and a 10× objective lens (CFI Plan Fluor 10×, Nikon Instruments) to monitor the entire flow due to its large field of view (FOV). At this stage, the study set a high pressure to achieve a rapid flow speed, ensuring that the injected cells swiftly entered the chip channel. Upon observing the sample fluorescence, the study switched to a 100× objective lens and adjusted the microscope stage to bring the sample flow into the FOV. Subsequently, the study transitioned to the light-field port and commenced acquisition. The sample fluorescence was excited using stroboscopic illumination to minimize the motion blur. By employing the high-speed streaming mode in the sCMOS camera, the study cropped the image size to 1024×1024 pixels or 1024×900 pixels, which covered all three elemental images, depending on the synchronization needs. The study then set the camera exposure time to 5 ms and initiated acquisition at a frame rate of 200 Hz for each cycle of 60,000 frames using HClmage Live 4.5.0.0 (e.g., 16-bit depth). The study repeated the aforementioned sample-loading step every 3-4 acquisitions to replenish the microfluidic chip with additional samples.

Stroboscopic illumination setup. The study set up the stroboscopic illumination scheme to shorten the illumination period within a camera exposure period (T_{cam}). Therefore, the effective camera exposure time (T_{eff}) was determined by the illumination period, with which cell movements may be constrained to less than half of the theoretical spatial resolution within T_{eff}. Quantitatively, the displacement d of a sample during T_{eff} can be calculated per Equation 1.

To suppress motion blur, the displacement d should be less than the lateral resolution of the exemplary LFC system at 400-600 nm. For experiments with T_{eff}=100 μs, the study constrained the sample speed to approximately 3 mm per sec, below the maximum allowable speed of 4-6 mm per sec, derived using Equation 1 based on the resolution. Similarly, for experiments with T_{eff} down to 5 μs, the flow speed was set to approximately 115 mm per sec, approaching the maximum allowable speed of 120 mm per sec. As seen, under both conditions, the sample displacement captured within one stroboscopic frame remained shorter than the lateral resolution of LFC, thereby mitigating motion blur. As a result, the motion blur can be effectively suppressed for fast-moving cells (FIG. 4A, subpanel (c)).

The study used a 200 Hz frame rate for image acquisition. The rolling shutter mode of the camera allowed for a 600-μs global exposure time for a 1024-pixel-by-1024-pixel frame. For multi-color imaging, the signal frequency of the two-color laser lines was set to be half of the camera frame rate (i.e., 100 Hz), and the two laser wavelengths were switched on and off alternately. The study designed two stroboscopic illumination schemes to adapt to various throughput requirements.

FIG. 4D shows the stroboscopic illumination method used in the cytometric image acquisition. For experiments with a cell speed within 10 mm/s, the study used NI DAQ devices, implemented into a personal computer chassis 402 (shown as PC chassis) to conduct stroboscopic illumination (FIG. 4D, subpanel (a)). An analog signal waveform was generated by a PCIe board 404 (e.g., PCIe-6738, National Instruments) and sent by a connector block 406 (e.g., CB-68LP, National Instruments) to the acoustic optical tunable filter (e.g., AOTF, 97-03926-12, Crystal Technology). At the same time, the analog signal waveform was synchronized with the camera signals by a LabVIEW program. Then, a BUS 408 (e.g., USB-6210, National Instruments) device was used to collect the digital signals from the camera as a feedback source. The DAQ devices were small and easy to implement into a desktop workstation or an optical system (e.g., 402), while they only supported an illumination period of no less than 100 μs. For higher-throughput imaging, the signal waveforms generated from DAQ devices became unstable.

The study used two function generators 410 and 412 (e.g., AFG3102, Tektronix) and an oscilloscope 414 (e.g., DPO5104, Tektronix) to perform stroboscopic illumination (FIG. 4D, subpanel (b)) for higher-throughput imaging. Rather than using camera signals from its internal trigger, the study used the external trigger mode of the camera 122 and drove the camera acquisition with a function generator (e.g., 410, 412). Since the internal clocks of the function generators were stable with no phase shifts within 3-4 rounds of data acquisition (15˜20 min), the study set up the two function generators 410 and 412 to control the camera 122 and the acoustic optical tunable filter 416 (AOTF) having channel 1 (shown as 416a, CH1) and channel 2 (shown as 416b, CH2), respectively. An oscilloscope 414 was used to monitor the waveforms and the synchronization between two function generators 410 and 412. In the experiments, the study set the square wave frequency as 200 Hz, peak width as 4.5 ms for the function generator 410 controlling the camera 122, and the square wave frequency as 200 Hz, peak width as 5 μs for the other generator 412 one controlling the AOTF 416. Therefore, the study increased the theoretical throughput by >50-fold with no noticeable motion blur compared with the method shown in FIG. 4D, subpanel (a).

Image processing. The study used a desktop workstation (e.g., Intel Xeon W-2145 3.70 GHz Processor, 64.0 GB RAM, Nvidia Geforce GTX 1080 GPU, 2560 NVIDIA CUDA Cores, 8 GB GPU memory, and Samsung Sm961 Series 1 TB Solid State Drive) to perform image acquisition. The data processing and analyses were conducted with another desktop workstation with an Intel Xeon E5-2620 v4 2.10× GHz Processor, 128 GB RAM, NVIDIA TITAN RTX GPU, 4608 NVIDIA CUDA cores, and 24 GB GPU memory. The numerical PSFs were generated using Python 3.5+ and CUDA C++ (with CUDA 10.1+). The study used MATLAB R2021+ with a CUDA-enabled GPU computing kit to implement hybrid point spread function (PSF) and 3D reconstruction. The study utilized the matrix operations in MATLAB, which helped reduce the use of loops. GPU computing facilitated the computation to be conducted parallelly. The study reconstructed volumes with 101 transverse layers, and the computing time for each transverse plane within a single iteration was less than 2 ms. As a result, the study can complete a single iteration of all the layers in less than 0.2 sec. For a 50-iteration 3D reconstruction, the total time consumed (excluding file reading and writing to disk) was about 8 seconds. The microfluidics system was controlled by Elveflow ESI software, and the imaging data was recorded by HCImage. The NI-DAQ-based stroboscopic illumination was controlled by a self-written LabVIEW program. The simulated PSF was generated by a self-written Python program integrated with CUDA C++ and OpenCL. The study used MATLAB R2022b, Python 3.9+ (including PyVista [42′] for 3D rendering), Origin 2023, and Fiji ImageJ (including the ClearVolume [43′] for 3D rendering and 3D ImageJ suite [44′] for 3D segmentation) for further data processing and visualization.

FIG. 4E shows the image processing flowchart (shown as 200b in FIG. 2B) of the exemplary LFC system. As shown, at step 420, the acquired images were first converted by lab-written Python and MATLAB codes to multipage TIFF images. Then, at step 422, the images were screened to exclude non-specific fluorescence from blank frames and sample debris (shown as step 220 in FIG. 2B). For multi-color imaging, at step 424, the two adjacent frames were selected, and each fluorescence representing certain subcellular signals was identified and sorted into separate folders. At step 426, the sorted data were sent for rolling-ball background subtraction and ACsN denoising for image SNR enhancement. If the image had a size of 1024×900 pixels, it was then be padded to 1024×1024 pixels.

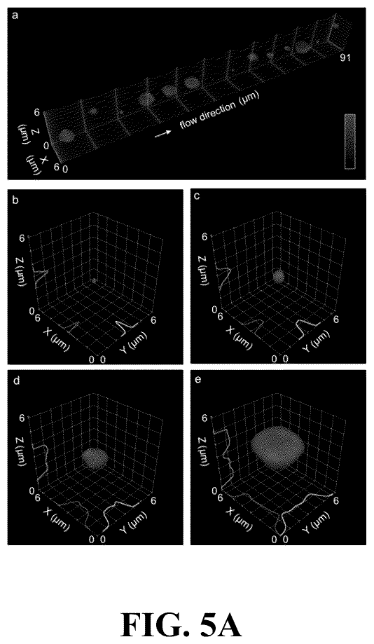

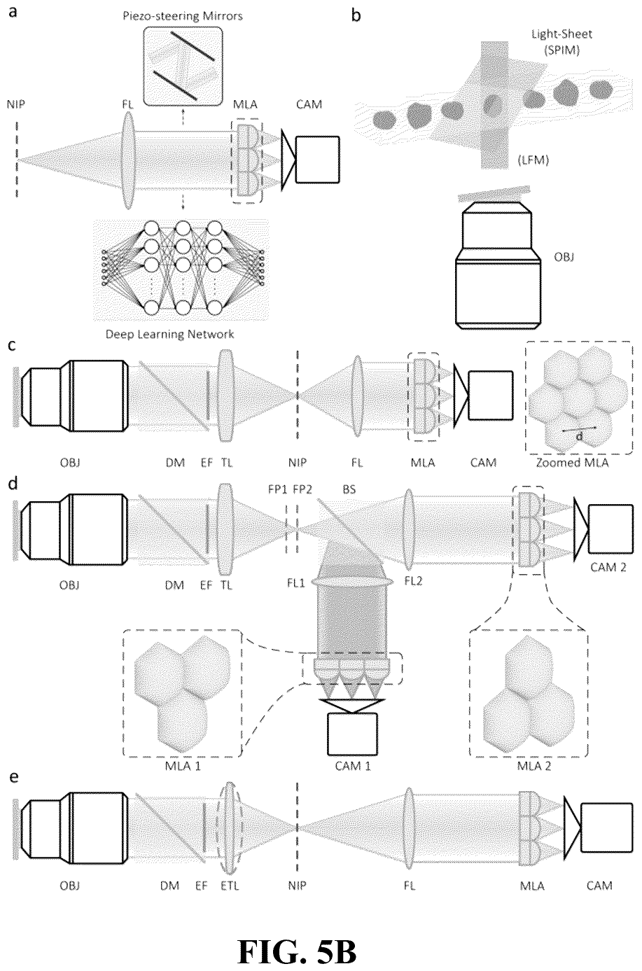

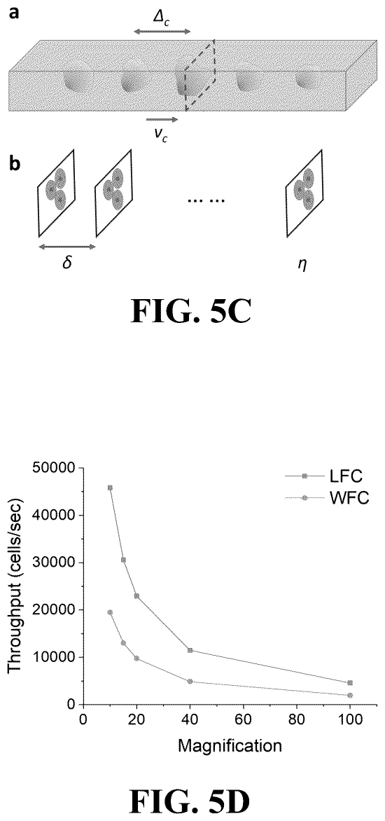

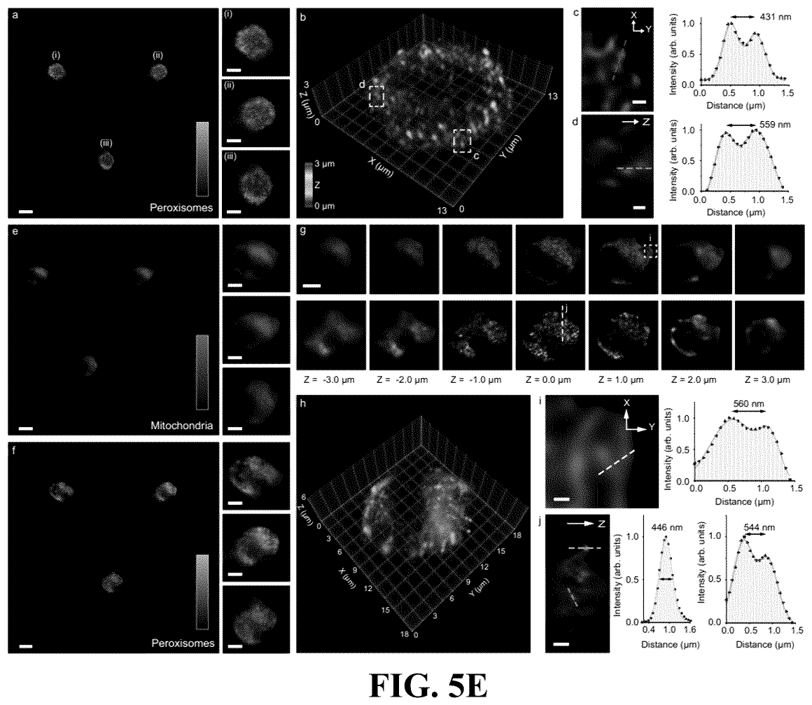

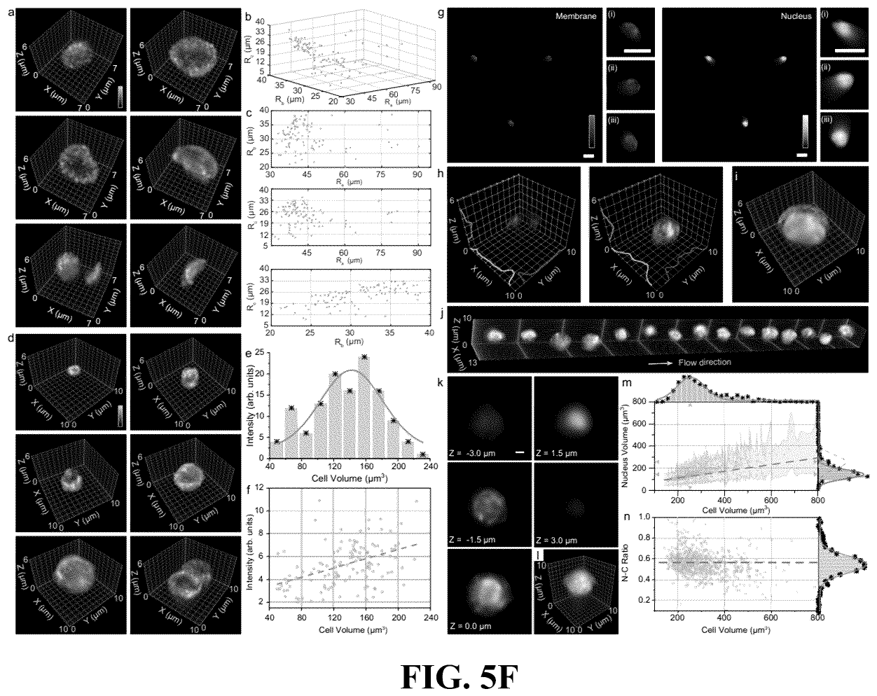

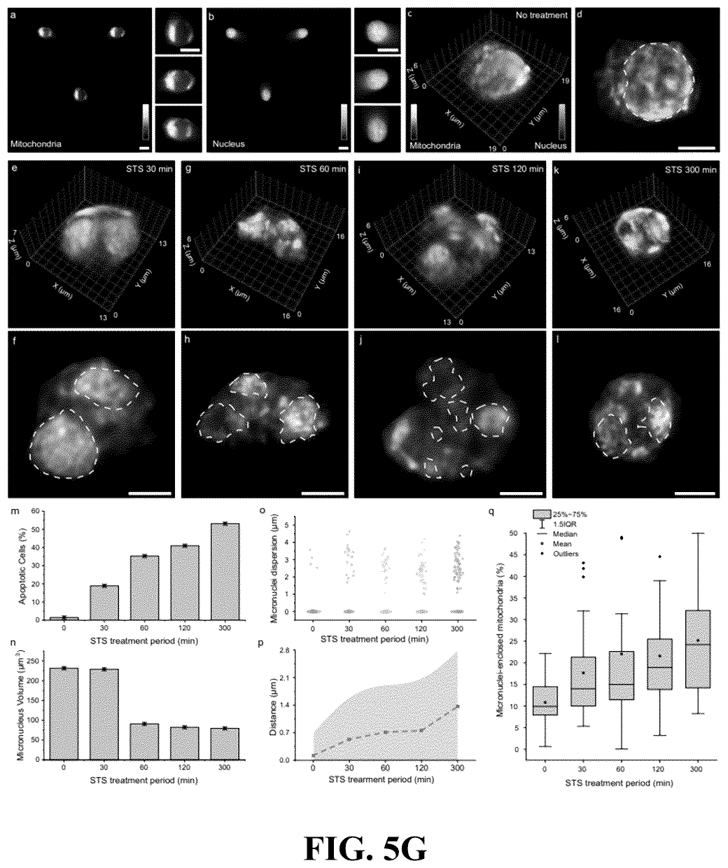

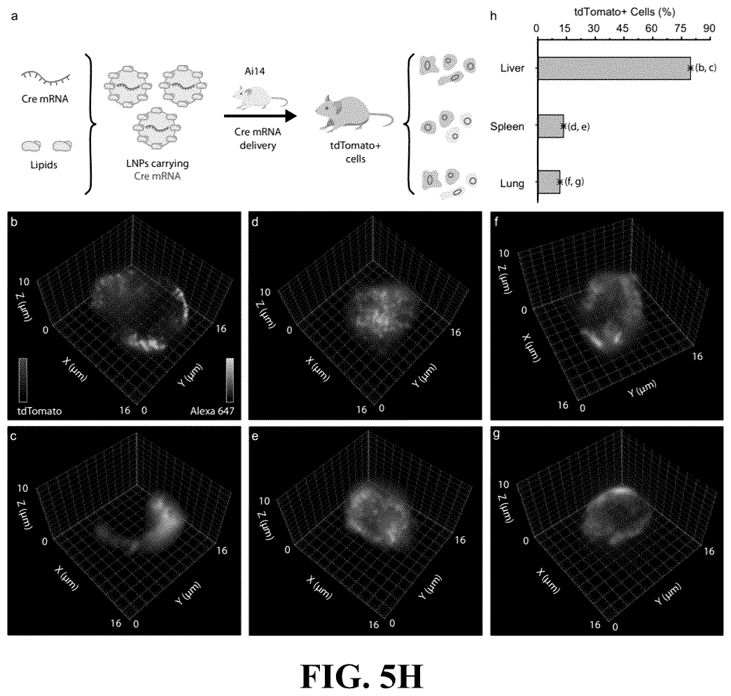

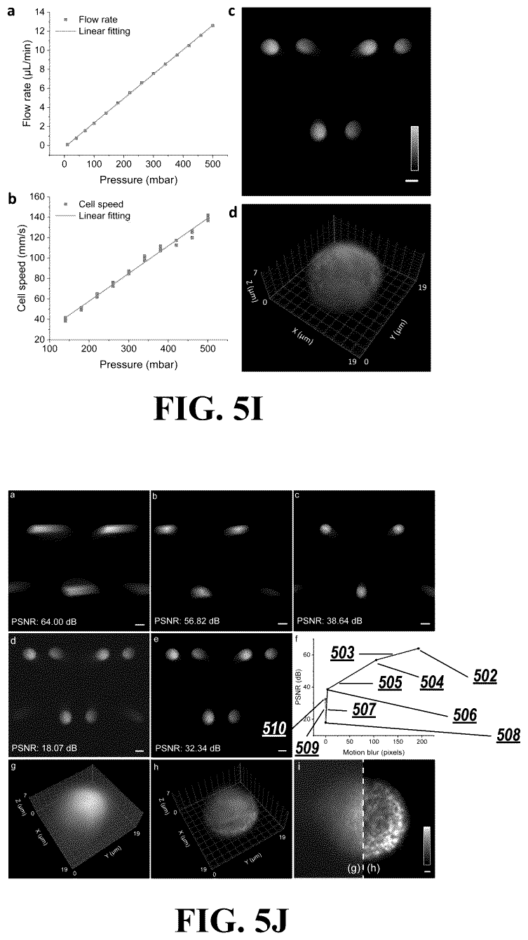

For 3D reconstruction, the study employed a graphic card (e.g., Titan RTX, Nvidia) to accelerate Richardson-Lucy deconvolution (RLD). For phantom imaging, the study used 30 iterations for the RLD of fluorescent microspheres. For biological samples, the study used 50 to 80 iterations for RLD. In the study, the current desktop can complete a single iteration with 1024 pixels×1024 pixels×101 pixels hybrid PSF within 0.2 s, and thus, a single 3D volume can be recovered within about 10 seconds [43]. For volume visualization, ClearVolume (version 1.4.2) was used to render 3D volume in all figures except for FIGS. 5A and 5F, which was rendered using PyVista72 (version 0.38.4) with customized code.

Vectorial Debye Model and Reconstruction Process. The study derived the wave function at the native image plane (NIP) in Equation 2 using the vectorial Debye theory to address the high numerical aperture (NA) of the objective lens and the corresponding refractive-index mismatch (RIM) between the objective lens immersion medium and the sample solution.

In Equation 2, f_{obj} is the objective focal length. J₀ and J₂ are the zeroth and second-order Bessel functions of the first kind, respectively. v and u represent normalized radial and axial coordinates and are defined by Equations 3 and 4, respectively. In Equations 2, 3, and 4, p=(p₁, p₂, p₃)∈ [symbol] is the point source in the object space; X=(x₁, x₂)∈ [symbol] represents the image position on the NIP. M is the objective magnification; α is determined by the minimum half-angle of NA and the critical angle of total internal reflection, i.e., α=min[sin⁻¹(NA/n₁), sin⁻¹(n₂/n₁)]. The wavenumbers k_{1,2}=2πn_{1,2} \hat{k}_{1,2}/λ were calculated using emission wavelength λ, refractive index n₁ of the immersion medium, and refractive index n₂ of the sample solution. θ₁ and θ₂ are the refractive (objective side) and incident (sample side) angles at the media interface, respectively.

In Equation 2, the aberration function Φ(l), the Fresnel transmission coefficients τₛ and τₚ can be defined per Equations 5, 6, and 7. In Equations 5, 6, and 7, 7 is the normal focusing position (NFP). In the imaging system, the refractive index of the immersion oil n₁ is 1.515, and n₂ is 1.33 for the PBS solution. For computational convenience, the study set the azimuthal angle of the emitter in the polar coordinates φₚ=90° since the fluorescence from the emitters exhibited an isotropic polarization so that the light field only pointed to the p₁ direction.

Next, the image at the NIP Uᵢ(x, p) was optically Fourier transformed onto the back focal plane of the Fourier lens, described as O [symbol] T[Uᵢ(x, p)], which was then modulated by the MLA. The modulation was described by the transmission function ϕ(x′), where x′=(x₁′, x₂′)∈ [symbol] represents the coordinates on the MLA. Specifically, the study described the microlens aperture as a hexagonal amplitude mask hex (x′/d), combined with a phase mask

$$exp ( \frac{- i k}{2 {f}_{M L}} {‖ {x}^{′} ‖}_{2}^{2} ) ,$$

where k=2π/λ is the wavenumber in the air. The modulation induced by a microlens is then defined per Equation 8.

Thus, the entire modulation can be described by the convolution of ϕ(x′) with a comb function comb_{Δ}(x′/d) that corresponded to the three microlenses shown in FIG. 4C, i.e., Φ(x′)=ϕ(x′), where ⊗ represents the convolution operator.

The light field propagation from the MLA to the camera can be modeled using the Fresnel propagation over a distance of f_{ML} per Equation 9. In Equation 9, x″=(x₁″, x₂″)∈ [symbol] represents the positions on the camera plane. The exponential term is the Fresnel transfer function. fₓ and f_{y} are the spatial frequencies in the camera plane. [symbol] and [symbol] ⁻¹ represent the Fourier transform and inverse Fourier transform, respectively. In practice, the Fresnel propagation over distance f_{ML} was calculated in small steps for computational accuracy. The final intensity image O(x″) at the camera plane containing elemental images of each microlens is defined per Equation 10. In Equation 10, g(p) is the intensity distribution of the volume of isotropic emitters in the object space.

In Equation 10, the intensity image at the camera image can be described as O=HG, where the measurement matrix H was determined by the PSF. The elements h_{j,k}, in H represent the light projection from the k-th volume g^{(k)} in the object space to the pixel O(j) on the camera plane. Therefore, the reconstruction becomes an inverse problem of retrieving the radiant intensity at each point of the 3D object volume with the camera image O, which can thus be derived per Equation 11. In Equation 11, the operator diag diagonalizes a matrix. This expression is a modified deconvolution algorithm based on the Richardson-Lucy iteration scheme. In the study, the sampling pixel sizes for reconstruction are Δ_{xy}=153 nm and Δ_{z}=100 nm. For visualization, the study additionally interpolated 2×2×2 pixels into each reconstructed pixel to match the camera pixel size.

The 3D deconvolution iteratively performed forward projection (Hg^{(k)}) and back projection (H^{T} O and H^{T} Hg^{(k)}) between the 3D object space and the 2D camera plane. The spatially invariant 3D PSF PSF(x″, z)=|h(x″, p)|² can be described and numerically derived by an on-axis emitter p=(0, 0, z). As a result, the forward projection can be obtained by summing up the 2D convolutions on each layer within an axial range [z₀, z₁] per Equation 12. In Equation 12, g^{(k)}(z) represents a single layer located at z in the 3D object volume. Hence, the back projection can be given per Equations 13 and 14. In Equations 13 and 14, PSF′(x″, z) was acquired by rotating PSF(x″, z) by 180 degrees.

Calibration. FIG. 4F shows the point spread function (PSF) calibration process in the exemplary LFC system. Subpanel (a) shows the experimental PSF of Fourier light-field microscopy. Subpanel (b) shows the calibration between experimental PSF and simulated PSF. Subpanel (c) shows the hybrid PSF after calibration. Subpanel (d) compares hybrid PSF in LFC, hybrid PSF in a previous study, and hybrid PSF in a different refractive index.

The spatial positions of the elemental images of the numerical PSF were adjusted based on the experimental results to compensate for any instrumental misalignment between the theoretical model and the actual optical system. Moreover, the use of hybrid PSF values circumvented the intensity value discreteness of the experimental PSF since the sCMOS-recorded images were unsigned integer values representing the photon numbers acquired by the camera chip. On the contrary, the numerical PSF images provided a double precision to estimate the PSF better, thereby enhancing the accuracy of the 3D information retrieval of the object.

In practice, the study calculated the Fourier transform (i.e., the optical transfer function, OTF) of the PSF as OTF= [symbol] T{PSF} in advance to enhance the computational efficiency before loading them into the GPU for iterative computation of forward and back projections. Specifically, the forward projection can be performed per Equation 15.

$$H {g}^{( k )} = {\sum }_{z = {z}_{0}}^{z = {z}_{1}} {ℱ}^{- 1} \{ OTF ( {x}^{″} , z ) . {G}^{( k )} ( z ) \} \qquad ( Eq . 15 )$$

In Equation 15, G^{(k)}(z) represents the Fourier transform of a single layer at z in the 3D object volume. Similarly, the back projection can be conducted per Equations 16 and 17.

$$\begin{matrix}[ {H}^{T} O ] ( z ) = {ℱ}^{- 1} \{ {OTF}^{′} ( {x}^{″} , z ) . F \{ O \} \} & ( Eq . 16 ) \\ [ {H}^{T} H {g}^{( k )} ] ( z ) = {ℱ}^{- 1} \{ {OTF}^{′} ( {x}^{″} , z ) . ℱ \{ H {g}^{( k )} \} \} & ( Eq . 17 )\end{matrix}$$

In Equations 16 and 17, OTF′(x″, z) is the transposed OTF(x″, z).

To further improve the spatial resolution of our LFC system, the study implemented radFLFM method using the radiality of the light-field images [5′]. The method achieved a better spatial resolution beyond the theoretical Fourier light-field resolution without compromising the throughput. FIG. 4G compares the performance of the reconstruction process with and without radiality analysis. Subpanel (a) shows the raw light-field images of mitochondria in flowing HeLa cells. Subpanel (b) shows the 3D reconstruction of raw light-field images in subpanel (a). Subpanel (c) shows the corresponding light-field image in subpanel (a) using ACsN and radiality analysis. Subpanel (d) shows the corresponding 3D reconstruction of the light-field image in subpanel (c).

Additionally, the study made substantive advancements in the algorithmic framework, specifically incorporating deep neural networks for image reconstruction. To elaborate, traditional Richardson-Lucy deconvolution algorithms were replaced by deep-learning algorithms optimized for 3D light-field image retrieval. Using the conventional Richardson-Lucy deconvolution (RLD) method required 30-50 iterations to retrieve the volumetric details of samples with near-diffraction-limited resolution, which can take around 8-10 seconds. This can be time-consuming when dealing with terabytes of IFC data. However, 3D volume prediction can be achieved in as little as 60-80 milliseconds using a deep learning approach and a well-trained U-Net network. This means that the deep-learning-powered reconstruction was over 100 times faster than the conventional RLD method, making it possible to analyze large data sets.

FIG. 4H shows the implementation of the deep-learning model in image reconstruction for the exemplary LFC system. For the training dataset, the study utilized a collection of 500 previously acquired wide-field volumes featuring HeLa peroxisomes shown in subpanel (a). These volumes were subjected to deconvolution using a 3D wide-field PSF to enhance their SNR, thereby serving as a ground truth(GT), shown in subpanel (b). Subsequently, these deconvolved wide-field volumes were convolved with a 3D light-field PSF to generate synthetic light-field images. The resultant elemental images were segmented and compiled along the channel dimension to create the training input for the neural network as shown in subpanel (c). The network architecture was based on the U-Net framework, as depicted in subpanel (d).

To accommodate the GPU memory constraints of the workstation, the training inputs were resized to dimensions of 512×512×3 pixels, while the ground truths were resized to 512×512×64 pixels. The voxel dimensions were set at 130 nm×130 nm×65 nm. The network underwent 500 training epochs, completed in approximately 5-6 hours, utilizing an Nvidia TITAN RTX graphics card for computation. The deep learning-generated reconstructions of peroxisomes (subpanel e), mitochondria (subpanel h), and flowing HeLa cell peroxisomes (subpanel k) were shown in subpanels (f)-(l) and were compared with corresponding wide-field scanning results in subpanels (g) and (j) and Richardson-Lucy deconvolution (RLD) results in subpanel (m). The quality of the deep learning reconstructed image was comparable to that achieved through wide-field scanning results and deconvolved results. The intensity values were normalized to a 0-1 scale. The image quality of the deep learning results was measured with 3D structure similarity indices (3D SSIM) and peak signal-to-noise ratios (PSNR).

Bead phantom preparation. The study used 200 nm, 1 μm, 2 μm, and 4 μm fluorescent beads for phantom sample imaging. The study mixed the four types of beads with an amount of 10 μL, 50 μL, 100 μL, and 200 μL, respectively, and diluted the solution to 3 mL with 1×PBS for experimental observation.

Animal subjects. All animals used in the study were housed at the animal facility at Georgia Institute of Technology. Ai14 mice (age of 6-18 weeks) and C57BL/6J mice (age of 8-12 weeks) were housed with a room temperature range between 2° and 26° C., humidity of 40-70%, and a seminatural light cycle of 12:12 light-to-dark ratio. OT-I mice (age of 6-8 weeks) and C57BL/6 mice (age of 6-8 weeks) were housed at a room temperature range between 2° and 21.7° C., a humidity of 30-55%, and a semi-natural light cycle of 12:12 light-to-dark ratio.

HeLa cell culture and mitochondria and peroxisome two-color staining. HeLa cells (e.g., #93021013, Sigma-Aldrich) were cultured in Dulbecco's modified Eagle medium (DMEM) with 10% fetal bovine serum (FBS) and 1% Penicillin-Streptomycin (Pen-Strep) at 37° C. in a 5% CO2 atmosphere. Before the imaging day, the cells were incubated in a prewarmed (37° C.) mixed solution containing 3 mL modified DMEM and 60 μL Peroxisome-GFP. The GFP was expressed on the peroxisomes after 22 hours of incubation.

On the imaging day, 0.3 μL of 1 mM Mito Tracker Deep Red FM stains were added to the growth medium. The cells were incubated for an additional 30 min. Then, the growth medium was removed, and the cells were washed twice using HBSS without phenol red. After HBSS was removed, 1.5 mL of trypsin-EDTA was added to the dish for 1 min, gently swirled, and removed. The cell dish was placed inside the incubator for 3 min to detach the cells. Once incubation was done, cells were resuspended into 3 mL of 4% PFA fixation buffer (16% PFA with PFA:PBS:ultrapure-water in a 1:2:1 ratio) in a 5 mL vial at room temperature for 12 min. Cells were concentrated by centrifuging for 6 min at 800×g. Then, cells were resuspended into 3 mL of clear PBS. This washing step was repeated again, and cells were finally stored in 3 mL of PBS without phenol red for imaging.

Mouse spleen and blood cell isolation and staining. C57BL/6J mice (N=3 mice/group) were sacrificed for spleen cells and blood cell collection. The spleen was minced and transferred to Eppendorf tubes containing 1×PBS. Next, it was filtered through a 70 μm mesh (Biologix Research Company 15-1070); 7 mL of PBS was added, and the cell suspensions were centrifuged at 800×g for 7 min. Spleen cells were subsequently resuspended in 1×PBS. Blood was collected through cardiac puncture. Blood cells were washed with 1×PBS and resuspended in 1×PBS for further imaging processing.

For spleen cells, 15 μL of wheat germ agglutinin (WGA) was added to each vial of spleen cells for 25 min incubation at 37° C. Then, the solution was washed twice with 1.5 mL phosphate-buffered saline (PBS) in the centrifuge with 800× g for 6 min. 1.5 mL of 4% paraformaldehyde solution (PFA) was added to perform fixation at room temperature for 15 min. After fixation, the solution was washed twice with 1.5 mL PBS in the centrifuge with 800× g for 6 min. 1.5 mL PBS with 5 mM EDTA was added to each vial before imaging.

For blood cells, 15 μL of WGA was added to each vial of blood cells for 25 min incubation at 37° C. Then, the solution was washed twice with 1.5 mL PBS in the centrifuge with 500× g for 5 min. 1.5 mL of 4% PFA was added to perform fixation at room temperature for 15 min. After the fixation, the solution was washed twice with 1.5 mL PBS in the centrifuge with 500× g for 5 min. 3 mL PBS with 5 mM EDTA was added to each vial before imaging.

Mouse naïve T cell isolation and staining. OT-I mice (N=1 mice/group) were sacrificed, and the spleens were mechanically digested into cell suspension, and CD8+ T cells were negatively purified from cell suspension with an untouched CD8+ T cell isolation kit. On the imaging day, 2.5 mL of T cells suspended in Rosewell Park Memorial Institute (RPMI) medium was transferred into a 35 mm FluoroDish. 12.5 μL of SYTO16 was added to the dish, and cells were incubated for 1 hour. At the 45-min time point, 2.5 μL of 1.2×HCS CellMask Deep Red staining solution was added. The 1.2×HCS CellMask staining solution was prepared by adding 2.4 μL of the HCS CellMask stock solution (250 μg HCS CellMask Stain with 100 μL of Dimethyl sulfoxide) to 10 mL PBS. The staining of HCS CellMask and SYTO16 was completed at the same time. Then, cells were transferred to a 5 mL vial and centrifuged (300× g, 16 min) to be collected. The cell pellet was resuspended using 1.8 mL of HBSS. The centrifuge resuspending procedure was repeated twice. In the last round, cells were resuspended into 1.8 mL of the 4% PFA fixation buffer and centrifuged again (300× g, 16 min). Finally, the supernatant was discarded, and cells were resuspended into PBS for storage and flow cytometry imaging.

Human-activated T-cell isolation and staining. Human immune cells (e.g., peripheral blood mononuclear cells) were isolated by density gradient centrifugation (Lymphoprep density gradient medium and SepMate-15 mL tube). The cells were separated by a selection kit (e.g., EasySep Human CD3 Positive Selection Kit II). Dynabeads Human T-Activator was used at the ratio of 3:1 (bead-to-cell) to activate the T cells. With complete human T cell media (e.g., X-vivo 10 Serum-free Hematopoietic Cell Medium, 5% Human AB serum, 10 mM N-Acetyl-Lcysteine, and 55 μM 2-Mercaptoethanol), the mixture of activated cells was cultured and maintained with supplements (50 μg/mL recombinant human IL-2) at the concentration of 7×105 to 2×106 cells/mL. After day 7 of the culture, the mixture was diluted with Dynabeads at a ratio of 1:1 (bead-to-cell). On Day 9, human T cells were isolated at a concentration of between 7×105 and 2×106 cells/mL.

On the imaging day, 12.5 μL of SYTO16 was added to the dish, and cells were incubated for 1 hour. At the 45-min time point, 2.5 μL of 1.2×HCS CellMask Deep Red staining solution was added for another 15-min staining. Then, cells were transferred to a 5 mL vial and centrifuged (300× g, 16 min) to be collected. The cell pellet was resuspended using 1.8 mL of HBSS. The centrifuge-resuspending procedure was repeated twice. In the last round, cells were resuspended into 1.8 mL of the 4% PFA fixation buffer and centrifuged again (300× g, 16 min). Finally, the supernatant was discarded, and cells were resuspended into PBS for storage and flow cytometry imaging.

Jurkat cell apoptosis induced by staurosporine (STS) treatment and staining. Jurkat T cells (e.g., #88042803, Sigma-Aldrich) were cultured in RPMI with 10% FBS and 1% Pen-Strep as a modified RPMI medium at 37° C. and in a 5% CO2 environment. On the imaging day, 1 μM of STS was added to 4 cell dishes, incubating for 30, 60, 120, and 300 min, respectively, at 37° C. The following procedures for preparing cells in the 4 dishes were the same. After the treatment, cells were centrifuged (e.g., 500× g, 6 min, 37° C.) and resuspended into the modified RPMI medium. After two rounds of centrifuge-washing, cells were resuspended into 6 mL of modified RPMI medium. For fluorescence labeling, 250 nM of SYTO16 green stains were added to the culture dish, and the cells were incubated for 1 hour. At the halfway of incubation (30 min), 150 nM of Mito Tracker Deep Red FM stains were added to the culture dish. After another 30 min, cells were centrifuged (e.g., 500× g, 6 min, 37° C.) and resuspended into 6 mL of the 4% PFA fixation buffer. Cells were fixed at room temperature for 12 min. After fixation, cells were centrifuged (800× g, 6 min, room temperature) and resuspended into PBS twice. Finally, cells were stored in PBS for imaging flow cytometry.

Nanoparticle formulation and characterization. 20α-OH cholesterol lipid nanoparticle was formulated using a microfluidic device as previously described59. Briefly, lipid nanoparticle was created by rapidly mixing aqueous and organic phases in a custom-made microfluidic device that uses syringes for each phase, with a 3:1 flow rate (aqueous to organic). Cre mRNA73 was diluted in 10 mM citrate buffer. cKK-E12 was purchased from Oragnix Inc. (0-8744). C18PEG2K and 18:1 (49-Cis) PE (DOPE) were diluted in 100% ethanol and purchased from Avanti Lipids. Citrate and ethanol phases were combined in a microfluidic device by syringes at a flow rate of 3:1. The diameter and polydispersity of the LNPs were measured using dynamic light scattering (DLS). LNPs were diluted in sterile 1×PBS and analyzed. Particles were dialyzed in Slide-A-Lyzer G2 20 kD dialysis cassettes from Thermo Scientific, and the nanoparticle concentration was determined using NanoDrop.

Cell isolation and staining for Cre mRNA delivery experiments. Ai14 mice (N=4 mice/group) were injected with 20α-OH cholesterol lipid nanoparticle at a total dose of 0.25 mg/kg nucleic acid. Mice were sacrificed, and cells were isolated 72 h after injection with LNPs. Mice were perfused with 20 mL of 1×PBS through the right atrium. The liver, spleen, and lung were isolated. The liver and lung were cut and then placed in a digestive enzyme solution with Collagenase Type I, Collagenase XI, and Hyaluronidase at 37° C. at 550 rpm for 45 min. The spleen was minced and placed in 1×PBS. The cell suspension was filtered through 70 μm mesh, 7 mL of PBS was added, and the cell suspensions were centrifuged at 800×g for 7 min. Next, Lung and liver cells were stained with anti-CD31 (1:200 dilution), and the spleen was stained with anti-CD45 (1:200 dilution). Before staining, FC receptors were blocked with TruStain FcX™ antibody (1:100 dilution in 1×PBS) to avoid non-specific binding. Next, the samples were kept at 4° C. for 45 min until the staining was complete. The samples were then washed with 1×PBS, transferred to Eppendorf tubes, and resuspended in 1×PBS for further imaging processing.

Statistics and reproducibility. The fluorescence staining protocols were repeated at least twice for each experiment. During the data acquisition, samples were loaded and imaged by at least three independent imaging sessions for each experiment.

### Experimental Results

As shown in FIG. 4A, subpanel (a), the exemplary LFC system was constructed based on a high-resolution epi-fluorescence platform, which incorporated a 100×, 1.45 numerical aperture (NA) objective lens and an array of optical configurations. In particular, the epi-fluorescence image at the native image plane was Fourier transformed and partitioned by a customized hexagonal microlens array (MLA), forming elemental light-field images on the back focal plane of the MLA, which were captured by an sCMOS camera [43]. To ensure consistent cell occupancy within the light-field acquisition volume, hydrodynamic focusing was implemented into the microfluidic system by sheathing the sample with faster flows (FIG. 4A, subpanel b). Furthermore, stroboscopic illumination with coaxial laser lines (e.g., 488 nm, 561 nm, and 647 nm) was generated by function-generating devices [13], allowing for multiple single- or multi-color exposures within a single camera frame while eliminating motion blur at high flow speeds (FIG. 4A, subpanel (c)).

The captured elemental light-field images can be considered a convolution between the light-field point-spread function (PSF) and the object volume, which allowed for the 3D retrieval of the object through an inverse computational process (FIG. 5B, subpanels (d)-(f)). Specifically, the elemental images were first processed using a lab-written denoising algorithm ACsN to enhance sensitivity under low signal-to-noise (SNR) conditions resulting from short exposure times. Then, the images underwent wave-optics-based 3D deconvolution with a hybrid point-spread function, facilitating accurate volumetric reconstruction calibrated for system deviations while minimizing computational artifacts throughout the entire imaging depth [42], (FIG. 5B, subpanel (f)). By integrating optical, microfluidic, and computational strategies, unlike other high-resolution 3D optofluidic imaging strategies [47]-[49] that experience low throughput (e.g., 10-20 cells/sec), the exemplary LFC system enabled blur-free and volumetric visualization of various 3D subcellular morphologies at high speeds, reaching up to 5,750 cells/see while maintaining a high SNR.

Characterization of LFC with phantom samples. To characterize the exemplary LFC system, the study initially imaged phantom samples within the flow and assessed the 3D reconstructed multi-color images. FIG. 5A shows the characterization of the exemplary LFC system using fluorescent microspheres.

As shown, the study used a mixture of Tetra-Speck fluorescent microspheres with diameters of 200 nm, 1 μm, 2 μm, and 4 μm. These microspheres were injected at a flow rate of 0.4-0.6 μL/min (approximately 4.50 mm/sec, 5,000-10,000 objects/sec), hydrodynamically focused, stroboscopically excited by three laser lines with 100-μs illumination durations and recorded at 200 frames per second (fps). The reconstructed microspheres displayed a range of volumes within the flow (FIG. 5A, subpanel (a)). In particular, the 3D images of subdiffraction-limited 200-nm microspheres exhibited the full width at half maximum (FWHM) values at 337 nm, 291 nm, and 542 nm in the X, Y, and Z dimensions, respectively (FIG. 5A, subpanel (b)). Moreover, the 3D measurements of different phantoms aligned well with the physical profiles of the samples convolved with the expected near-diffraction-limited 3D resolution in the lateral and axial dimensions, respectively (FIG. 5A, subpanels (b)-(e)). Additionally, a >5× extended depth of focus (˜6 μm) was observed for high-resolution light-field acquisition compared to conventional epi-fluorescence microscopy. The measurements of the reconstructed objects revealed four distinct populations, in which both the microsphere diameters derived from the 3D volumes and the corresponding intensity matched the expected values. The results demonstrated that the LFC system can identify each subpopulation within the phantom mixture (FIG. 5A, subpanels (f)-(k)).

LFC imaging system characterization. The study calculated the lateral resolution of the imaging system per Equation 18.

$${R}_{x y} = \frac{1}{M} \times \frac{λ}{2 N {A}_{M L}} \times \frac{{f}_{F L}}{{f}_{M L}} \qquad ( Eq . 18 )$$

In Equation 18, M is the objective magnification, and A is the fluorescence wavelength. NA_{ML} is the numerical aperture of each microlens. The focal lengths of the Fourier lens and the microlenses are represented as f_{FL} and f_{ML}, respectively. The imaging system used a 100× objective lens with NA=1.45, λ is 680 nm for dark red fluorescence, 599 nm for orange fluorescence, and 510 nm for green fluorescence. The focal length of the Fourier lens is f_{EL}=275 mm. The NA of each microlens can be calculated as NA_{ML}=d_{ML}/2f_{ML}=0.014. Therefore, the lateral resolution was 575 nm for dark red fluorescence, 507 nm for orange fluorescence, and 432 nm for green fluorescence, consistent with the measurements of phantom samples (FIG. 5A, subpanels (b)-€) and biological samples (FIG. 5E, subpanels (c) and (i)).

The analytical model was derived based on elemental images in the raw Fourier light-field data, while the deconvolution process provided a moderate enhancement in the resolution. When estimating the sizes of the phantom samples, the study calculated the phantom volumes V and converted the values to diameters using

$$D = \sqrt[3]{6 V / π} .$$

The distributions revealed that the resolving capability of the LFC system was ˜500 nm (FIG. 5A, subpanels (f)-(k)).

The axial positions of the two emitters can be resolved laterally in the elemental images. Therefore, the study calculated the axial resolution of the imaging system per Equation 19.

$${R}_{z} = \frac{1}{{M}^{2}} \times \frac{λ}{2 N {A}_{M L}} \times \frac{{f}_{F L}}{{f}_{M L}} \times \frac{1}{tan {θ}^{′}} \qquad ( Eq . 19 )$$

In Equation 19, tan θ′=d_{ML}/(\sqrt{3}f_{FL}). In this case, the axial resolution can be obtained as 843 nm for dark red fluorescence, 743 nm for orange fluorescence, and 632 nm for green fluorescence, consistent with the measurements of phantom samples (FIG. 5A, subpanels (b)-(e)) and biological samples (FIG. 5E, subpanels (d) and (j)).

It is feasible to apply advanced strategies, such as light-field super-resolution algorithms (e.g., virtual-scanning light-field microscopy (VsLFM) [13′], hyper light-field microscopy (HyLFM) [14′]), digital adaptive optics [15′]) to enhance the resolution during the post-processing process. FIG. 5B shows the exemplary system employing VsLFM and HyLFM methods.

In subpanel (a), VsLFM enhanced resolution by leveraging multiple angles of view scanned by piezo-steering mirrors combined with a digital adaptive optics algorithm. In subpanel (b), HyLFM employed an additional light-sheet illumination, facilitating the simultaneous capture of high-resolution images that served as the training and validation datasets for deep learning networks. The study expected both techniques to achieve effectiveness in resolution enhancement. The study believes this to be the first integration of these methods into Fourier light-field and cytometric imaging fashions.

The study treated the full width of the axial PSF(i.e., 2× full width at half maximum (FWHM) in the axial direction) as the DOF of the system, which, therefore, can be calculated per Equation 20.

$$DOF = \frac{4 {R}_{x y}^{2}}{λ} ( 2 + \frac{{P}_{eff}}{{R}_{x y}} ) \qquad ( Eq . 20 )$$

In Equation 20, P_{eff} is the effective pixel size of the elemental image, which was 153 nm based on the configuration of the setup. Hence, the DOF was obtained as 4.41 μm for dark red fluorescence, 3.95 μm for orange fluorescence, and 3.44 μm for green fluorescence, which was consistent with the measurements of bead phantoms (FIG. 5A, subpanels (b)-(e)) and biological samples (FIG. 5E, subpanel (g)). The deconvolution in the reconstruction process using PSF considering spherical aberration can retrieve the diffracted information outside of the Rayleigh range of the axial PSF. Therefore, the LFC presents a depth of field (DOF) of ˜6 μm in experimental results (FIGS. 5E and 5F).

In FIG. 5B, to enhance the coverage, three practical solutions (1-3) can be executed to extend the DOF and further develop the exemplary LFC system. These solutions include the implementation of (1) a low-magnification objective lens, (2) an additional Fourier light-field path, and (3) an electrically tunable lens (illustrated in FIG. 5B, subpanels (c)-(e)). In particular, the initial alteration (1) involved transitioning to a 40× objective lens (e.g., Nikon CFI Plan Fluor 40×, 1.3NA Oil). This switch was concomitant with adjustments in the design parameters for both the micro-lens array (MLA) and the Fourier lens [16′] (FIG. 5B, subpanel (c)). The study developed the parameters for the MLA (f_{ML}=55.8 mm, pitch d=3.3 mm, 7 hexagonal microlenses) and the Fourier lens (f_{FL}=150 mm). Based on the Debye model, these modifications led to ˜1.5-fold improvement in the DOF (i.e., ˜8.2 μm), 3× expanded field of view (220 μm), 3D resolution of 600-850 nm and 1.1-1.5 μm in the lateral and axial dimensions, respectively. In the alternative solution (2), the study developed a multi-focal Fourier light-field design to enhance the DOF by placing an additional Fourier light-field path with an offset of 40 mm away from the native image plane so that the two Fourier light-field paths simultaneously captured connective focal ranges (FIG. 5B, subpanel (d)). The solution (3) replaced the normal tube lens with a focus tunable lens (e.g., an electrically tunable lens or ETL) so that different depth layers can be refocused corresponding to the focal changes of the ETL (FIG. 5B, subpanel (e)). By synchronizing the focal scan of the ETL and camera frames, the DOF can be extended by accumulating the images acquired from multiple frames.

The FOV was calculated at the focal plane in the object space of the system per Equation 21.

$$FOV = {d}_{M L} \times \frac{{f}_{F L}}{{f}_{M L}} \times \frac{1}{M} \qquad ( Eq . 21 )$$

Using the system configuration parameters, the study got a FOV of 76.39 μm×76.39 μm, which was consistent with the measurements (˜70 μm×70 μm) of the previous results [6′]. Table 2 summarizes the system parameters and the design principles of MLA.

TABLE 2

| Input parameters | | Design parameters | | |
|---|---|---|---|---|
| Emission wavelength λ (nm) | 516, 599, 680 (Use 600 for calculations) | Effective pupil size at the MLA Dₚᵤₚᵢₗ (mm) | $2 {f}_{FL} \cdot \frac{NA}{M}$ | 7.98 |
| Objective magnification M | 100× | Fourier lens focal length ƒ_{FL} (mm) | $\frac{M \cdot {D}_{pupil}}{2 NA}$ | 275 |
| Numerical aperture NA | 1.45 | Occupancy ratio N | $\frac{2 NA}{λ} \cdot {R}_{xy}$ | 2.45 |
| Camera pixel size P_{cam} (μm) | 6.5 | Microlens diameter d_{ML} (mm) | $\frac{{D}_{pupil}}{N}$ | 3.25 |
| Physical size of the camera sensor D_{cam} | 13.3 | Microlens focal length ƒ_{ML} (mm) | $\frac{{S}_{r} \cdot {P}_{cam} \cdot {d}_{ML}}{λ}$ | 117 |
| (mm) | | | | |

The study achieved an effective exposure time of 100 μs without any motion blur using the NI DAQ devices and 5 μs when using function generators and an oscilloscope. Therefore, the study claimed a temporal resolution of up to 5 μs with our current system configurations. The temporal resolution was constrained by the responding limit of the AOTF.

FIG. 5C shows the cell throughput estimation. Subpanel (a) shows cells flowing in the microfluidics channel at a speed of v_{c}, and Δ_{c} represents the cell-to-cell interval. Subpanel (b) shows the frame sequence during the high-throughput acquisition. δ represents the moving distance of cells between two adjacent frames (i.e., within one camera exposure time). η represents the camera frame rate.

As shown, assuming the cell flow was continuous and stable with a constant cell-to-cell interval, the cell throughput can be defined per Equation 22.

$${N}_{c} = \frac{{v}_{c}}{{Δ}_{c}} = \frac{δ \cdot η}{{Δ}_{c}} \qquad ( Eq . 22 )$$

In Equation 22, N_{c} is cell throughput, v_{c} is cell speed, Δ_{c} is cell-to-cell interval size, δ is the cell displacement between adjacent frames, and η is the camera frame rate.

The exemplary LFC system can achieve a cell speed of up to 115 mm/s. Assuming the cell-to-cell interval was twice the cell size (i.e., approximately 20 μm), the study claimed an analytical throughput of 5,750 cells/s. In multi-color imaging experiments, the relative distance of two cells between two adjacent frames was measured to estimate the cell speed. For example, in FIG. 5E, the relative distance between mitochondria and peroxisome images was 17.11 μm, equivalent to a flowing speed of 3.4 mm/s.

High throughput was an advantage of imaging flow cytometry (IFC) over traditional single-cell platforms. This advantage led to processing and analyzing thousands to millions of cells in a single experiment, orders of magnitude higher than conventional imaging techniques. Specifically, high throughput offered high content, multiparametric analysis, and statistical significance for large-scale cell studies and screening applications. These single-cell details allowed for identifying genes, pathways, and cell biological mechanisms at the population level underlying disease diagnosis in clinical settings [17′], [18′]. The high number of cells analyzed per sample increased the statistical power and reduced the impact of sample bias in the experiments, which was crucial for detecting subtle and rare phenotypic changes and for robust data interpretation in biological research. The automated nature of cytometric imaging allowed for rapid sample loading, data acquisition, and analysis, reducing the time and labor required for experiments. This efficiency was vital in high-throughput screening and large-scale studies. The throughput of IFC also enabled cell studies that necessitate imaging of fresh clinical samples or in their native state post-extraction from organs (e.g., FIG. 5H). In this case, confocal or super-resolution microscopy became limited. The high throughput system can be integrated with other technologies, such as mass spectrometry or genomics platforms, providing a more comprehensive analysis of the cellular state.

On the other hand, LFC overcame the trade-off between resolution and throughput that was inherent in existing IFC systems. High-resolution imaging provided detailed insights into subcellular structures, yet this was often at the cost of throughput. Conversely, systems tailored for enhanced throughput may compromise resolution. Theoretically, analytical throughput decreased quadratically to the increase in magnification (i.e., resolution) due to constraints imposed by the effective pixel size and the maximal flow velocity that precludes motion blur (FIG. 4A, subpanel (c)) [10′]. Conventional approaches may achieve high or super-resolution imaging by considerably restricting throughput [19′-21′].

However, LFC marked a significant advance by formulating an effective magnification of 42.5× (thereby enhancing the throughput) by combining the 100× objective lens with individual microlenses. FIG. 5D shows the analytical throughput of the exemplary LFC system and conventional wide-field cytometry as a function of objective magnification (e.g., 10×, 15×, 20×, 40×, 100×). As shown, LFC restored the near-diffraction-limited resolution, characterized by the 100× objective lens, through the wave-optics-based reconstruction of elemental light-field images. This combinatorial strategy represented a substantial advance in alleviating the resolution-throughput tradeoff for IFC while retaining the unique snapshot 3D ability of light-field imaging, which, as a result, surpassed the analytical throughput of conventional widefield systems.

Multi-color imaging of peroxisomes and mitochondria in flowing Hela cells. FIG. 5E shows the imaging results of peroxisomes and mitochondria in flowing HeLa cells with the exemplary LFC system. As shown, to demonstrate 3D subcellular imaging, the study first analyzed flowing HeLa cells labeled with peroxisome-GFP using 488-nm laser excitation. The cells were introduced at a slow flow rate of approximately 0.03 μL/min (˜0.11 mm/sec), and the GFP signals emitted by peroxisomes were captured without motion blur at 200 fps under continuous illumination. The reconstructed light-field image, based on a single camera frame, revealed the intricate 3D structures of peroxisomes prominently distributed across a cellular thickness over 3 μm (FIG. 5E, subpanels (a) and (b)). The vesicles, separated by as close as 400-600 nm, may be well-resolved in all three dimensions (FIG. 5E, subpanels (c) and (d)).

Furthermore, the study conducted two-color imaging of mitochondria and peroxisomes in flowing HeLa cells labeled with Mito Tracker and peroxisome-GFP, respectively. The exemplary LFC system captured the optical signals of both organelles at a flow rate of 0.4˜0.6 μL/min (˜3.4 mm/sec) using 488- and 647-nm lasers alternatively with 100-μs stroboscopic illumination duration at 200 fps (FIG. 5E, subpanels (e) and (f)). The flowing cells displayed a native, sphere-like morphology, and the reconstructed two-color images depicted the intricate 3D spatial relationship between peroxisomes and mitochondria across a significant thickness (˜6 μm) of the cells (FIG. 5E, subpanels (g) and (h)). The high resolution and volumetric capabilities enabled visualization of structural variations as close as 400-600 nm for both organelles in all three dimensions (FIG. 5E, subpanels (i) and (j)), consistent with the resolution measurements obtained using the phantom samples. These results, enhanced by effective denoising, displayed reliable reconstruction under varying SNR conditions and high accuracy compared with other modalities, such as epi-fluorescence and 3D structured-illumination microscopy (SIM).

Analyzing morphological features of isolated cells from mice and humans. The study subsequently demonstrated 3D cytometric imaging of heterogeneous cell populations using the exemplary LFC system. FIG. 5F shows the comparative analysis of cell morphologies in isolated mouse and human cells.

Specifically, the study analyzed membrane-labeled blood cells (FIG. 5F, subpanels (a)-(c)) and spleen cells (FIG. 5F, subpanels (d)-(f)) extracted from adult mice, which were introduced at a rate of approximately 600 cells/sec. The imagery obtained displayed high specificity and sensitivity for differentiating various 3D morphological features using K-means clustering algorithm and quantifying their staining intensity on a cell-by-cell basis with a high throughput ˜2,300 cells/sec (FIG. 5F, subpanels (a)-(f)). Next, the study labeled and imaged the membrane and nucleus of mouse naïve T cells (FIG. 5F, subpanels (g)-(i)) and human-activated T cells (FIG. 5F, subpanels (j)-(n)) and imaged these samples at a rate of ˜300 cells/sec. The study applied alternating 488-nm and 647-nm illumination, each with a 100-μs stroboscopic illumination time, and captured images at 200 fps. The study quantified the hollow structures of the cell membrane in all three dimensions, which were shown to enclose the nucleus of each cell (FIG. 5F, subpanels (h) and (i)). The membrane stain exhibited a consistent thickness of 500-600 nm across three dimensions, in agreement with the measured 3D resolution of the LFC system (FIG. 4A, subpanels (b) and (e))). Moreover, the reconstructed focal stacks of the human-activated T cells displayed two distinct sizes of the cell membrane (7.99 μm) and nucleus (6.57 μm) (FIG. 5F, subpanels (k) and (m))). Notably, the volumetric capability of LFC considers diverse 3D cell morphologies, thereby facilitating accurate 3D cellular quantification, unlike the estimations derived from 2D widefield images that assume a spherical cell shape [50]. As a result, the study identified the nuclear-to-cytoplasmic (N: C) ratio of immune cells by directly measuring the ratio of nuclear volume to total cell volume, which exhibited a mean N: C ratio of 0.55 (FIG. 5F, subpanel (n)), consistent with the previously reported results [13], [15], [51].

K-means clustering algorithm for blood cell morphology identification. The k-means clustering algorithm is a machine-learning algorithm that can partition the observations into k clusters where the elements within the cluster have the smallest distance mean (i.e., nearest mean) [23′]. Mathematically, the minimization operation of the algorithm can be defined per Equation 23.

$${\sum }_{i = 1}^{k} {\sum }_{x ∈ {X}_{t}} {‖ x - {X}_{i} ‖}^{2} \qquad ( Eq . 23 )$$

In Equation 23, X={x₁, x₂, . . . , xᵢ, . . . , xₖ} is the clustered dataset. Using MATLAB functions, the study applied this algorithm to identify blood cells with different morphologies. First, the study used the radii along three axes from the ellipsoid fitting results as clustering parameters and imperially set the cluster number to be 3. The results identified three types of cells: (A) adhered cell pairs, (B) single spherical cells, and (C) single non-spherical cells. Then, the study used the eccentricity values along two of the three axes as the clustering parameters to further identify more morphological feathers. The study set the cluster number to 2 to further cluster the results from group (A) and group (B). The results showed that for group (A), the algorithm further identified (A1) smaller spherical cells and (A2) larger spherical cells; for group (B), the algorithm further identified (B1) elliptical cells and helmet-shape cells and (B2) stick-like cells and cell fragments. Hence, the entire clustering process identified 5 types of morphologies based on the 3D volumes of the cells.

Imaging morphological changes in staurosporine-treated Jurkat cells. Programmed cell death is a crucial stage for proper tissue and organ functioning, and its malfunction is associated with various diseases [52], [53]. Apoptosis, one of the primary pathways of programmed cell death, involved numerous morphological and functional changes inside cells, such as chromatin condensation, nuclear fragmentation, loss of cell contact, and organelle swelling [54]. Staurosporine (STS), a protein kinase inhibitor isolated from Streptomyces, has been used to induce apoptosis in various types of cells [55]. Since apoptosis occurred in a 3D manner in the cellular space, a flow cytometer with 3D imaging capability is essential for observing apoptotic status with higher sensitivity and accuracy. The study demonstrated LFC to investigate 3D subcellular morphological alterations of human T lymphocyte (Jurkat) cells arising from STS-induced cell apoptosis. Experimentally, the study conducted cytometric imaging of Jurkat cells after treatment with 1-μM STS for 30, 60, 120, and 300 min.

In comparison with wide-field images, multi-color LFC captured multiple organelles of flowing cells, such as the nucleus and mitochondria, with high resolution and clarity, enabling the visualization of the 3D morphology of their subcellular organizations. FIG. 5G shows the morphological changes in Staurosporine (STS)-treated Jurkat cells visualized through the exemplary LFC system.

As shown, the apoptotic morphological changes were validated using epifluorescence and 3D SIM. The previously spherical and intact nuclei underwent morphological changes, exhibiting fragmented and condensed nuclear dispersion throughout the cell, a characteristic feature of cells undergoing apoptosis [56] (FIG. 5G, subpanels (d)-(l)). With the treatment period increased, the Jurkat cell nuclear morphology displayed reduced volumes and fragmented micronuclei. Consequently, over 53% of the cells showed apoptotic nuclei after 5 h of treatment (FIG. 5G, subpanels (m)-(p)). Meanwhile, during the dispersion of fragmented nuclei within the cellular volume, organelles such as mitochondria experienced an increased degree of enclosure amidst the interstitial spaces of the micronuclei (FIG. 5G, subpanel (q)). These results underscored the utility of LFC in elucidating the delicate subcellular morphological alterations associated with various cell functions and dysfunctions within 3D volumetric, multiparametric, and population-based contexts.

Image-based analysis of tdTomato expression after Cre mRNA delivery. Lipid nanoparticles (LNPs) carrying mRNA have been used in two COVID vaccines and earlier-stage clinical trials that have generated promising results [57]. However, visualizing and quantifying functional mRNA delivery (i.e., the subsequent protein expression) has been challenging. To evaluate whether 3D IFC could achieve this goal, the study formulated a liver-targeting LNP [58], so it carried mRNA encoding Cre recombinase using microfluidics [59]. The study then intravenously administered the LNPs to Ai14 mice at the clinically relevant dose of 0.25 mg/kg.

FIG. 5H shows the detection of Cre mRNA expression with lipid nanoparticle (LNP)-delivery in isolated mouse cells. In these mice, functional mRNA delivery led to Cre protein, which then translocated into the nucleus, leading to the expression of tdTomato (5H, subpanel (a)). Three days after LNP administration, the study used LFC to assess the expression of tdTomato in the liver, spleen, and lung after Cre mRNA delivery in Ai14 mice. As observed, two-color LFC offered high sensitivity for the 3D visualization of individual cells and their gene expression in different organs (FIG. 5H, subpanels (b)-(g)). Examining the percentage of cells expressing tdTomato (tdTomato⁺), the study demonstrated that the liver cells were more targeted by LNPs with functional Cre mRNA delivery, with a tdTomato⁺ cell percentage of 79.41%, compared to 13.45% and 11.39% in the spleen and lung, respectively (FIG. 5H, subpanel (h)). These 3D image-based analyses showed consistent results (i.e., approximately 80% in the liver and, less prominently, <20% in other organs) as shown using fluorescence-activated cell sorting (FACS) [58].

Additional experimental results and examples may be found in Hua, X., Han, K., Mandracchia, B. et al. Light-field flow cytometry for high-resolution, volumetric and multiparametric 3D single-cell analysis. Nat Commun 15, 1975 (2024), which is incorporated by reference herein in its entirety.

Jurkat cell nucleus imaging with higher throughput. FIG. 5I shows the higher throughput imaging with the Jurkat cell nucleus. Subpanel (a) shows the scatter plot for the flow rate measured by a microfluidics sensor and pump pressure with linear fitting. Subpanel (b) shows the scatter plot for cell speed measured with acquired image sequences and pump pressure with linear fitting. Subpanel (c) shows the light-field raw image of a Jurkat cell with the dual-snapshot scheme. Subpanel (d) shows the visualization of the 3D reconstruction of the Jurkat cell in subpanel (c).

Using function generators and an oscilloscope, the study achieved a more stable stroboscopic illumination in the exemplary LFC system, facilitating imaging with higher throughput. The study used a large field of view (more than twice the size of a Jurkat cell) and implemented a dual snapshot scheme to image a single cell twice in one frame. By controlling the time interval of two snapshots and measuring the distance between two shots, the study can estimate the cell speed, which can be further used to estimate the cell throughput. In practice, the study first calibrated the relations between microfluidic pump pressures and flow rates read from a microfluidic flow sensor (e.g., MFS, Elveflow). The linear trend of the curve (subpanel (a)) facilitated linear interpolation when the study set the pressures to specific numbers for a desired flow rate. Secondly, the study maintained the distance between two snapshots at ˜150 pixels on the camera and calibrated the relations between pump pressures and cell speeds. Their linear relations (subpanel (b)) also provided interpolation between the calibrated data points. After the calibrations, the study set the microfluidic pump pressure to 414 mbar for the main sample channel and 622 mbar for the side channels to allow a flow rate of ˜10.87 μL/min. The study set the peak interval of the square wave signals to 239.81 μs and the peak width to 5 μs. The results shown in subpanels (c)-(d) exhibited no motion blur and can be reconstructed volumetrically within the field of view and a depth of focus of ˜5 μm. The distance between the two snapshots was 190 pixels, equivalent to 27.55 μm. Therefore, the cell speed was ˜115 mm/s. Assuming the cell-to-cell interval in the flow was around twice the cell size (˜20 μm), the theoretical cell throughput the study can achieve in the exemplary LFC system is ˜5,750 cells/s.

A shorter stroboscopic time may reduce motion blur but weaken the signal-to-noise ratio (SNR) due to the reduced photon count during the effective exposure time. To address this tradeoff, the study implemented lab-written algorithms (e.g., 200b in FIG. 2B), including background rejection and ACsN [1′]. While ACsN was validated for its efficacy in restoring low-SNR light-field images [5′-8′], its deployment in the flow setting was not demonstrated. In addition, the study optimized fluorescent staining protocols, selecting dyes and proteins through multiple rounds of testing to ensure robust results. As a result, the experimental data corroborated that even when utilizing stroboscopic illumination periods as brief as 5-μs, the exemplary method was proficient at restoring raw fluorescent light-field signals for precise 3D image reconstruction (FIG. 5I). Efficient illumination and denoising was employed for recent high-throughput 2D IFC methods, utilizing stroboscopic illumination durations of 10-20 μs [9′], [10′]. Hardware solutions such as VIFFI [11′] or FIRE [12′] were also developed by high-throughput 2D IFC techniques to recover a high SNR, however, at the expense of increased instrumental complexity.

Furthermore, the study conducted additional experiments with various stroboscopic illumination periods. FIG. 5J shows the image quality of different noise and motion-blur levels and the effects of using ACsN method. Subpanels (a)-(d) show the light-field images of the nucleus of flowing Jurkat cells with 5-ms, 2.7-ms, 100-μs, and 5-μs effective exposure time, respectively. Subpanel (e) shows the ACsN denoised light-field image of the subpanel (d). Subpanel (f) shows the relationship between motion blur and SNR. Lines 503, 505, and 507 and dots 502, 504, 506, and 508 represent images without ACsN, and dot 510 represents the image with ACsN. The dashed arrow 509 shows the improvement of SNR by the denoising algorithm. Subpanels (g) and (h) show the 3D reconstruction of subpanels (d) and (e), respectively. Subpanel (i) shows the 2D images on the focal plane of subpanels (g) and (h), respectively.

These experiments were accompanied by a quantitative analysis evaluating the SNR and image quality, both with and without the implementation of ACsN denoising. The results substantiate that the exemplary method elevated the quality of reconstructed images. The exemplary method provided compelling evidence supporting the optimized parameters the study employed in the exemplary LFC system, balancing robust SNR with minimal motion blur.

### Discussion

Discussion #1. Flow cytometry and fluorescence microscopy are two driving forces for biological and medical research. Flow cytometry allows for the rapid analysis of diverse cellular populations, while fluorescence microscopy provides a high-resolution image of individual cells. The emergence of imaging flow cytometry (IFC) combines these strengths, enabling high-throughput, multiparametric single-cell analysis with rich spatial details, high sensitivity, and molecular specificity [1-4]. The ability to acquire cytometric images allows for the direct visualization of cell properties, such as size, shape, biomarker intensity, physiological state, and other morphological and biochemical characteristics [5]. IFC technologies have been applied across various basic and translational fields, including cell biology [6], immunology [7], [8], microbiology [9], hematology [10], and cancer research [11], [12].

Advancements have been made in cytometric imaging capabilities, such as speed, sensitivity, and resolution, through the integration of various fluorescence microscopy strategies [13-19]. However, current IFC systems, in comparison with other single-cell imaging platforms, remain disadvantageous in the data acquisition at higher resolution and dimensions [3]. While some IFC approaches have achieved sub-micrometer resolution with high throughput [14], [15], they generate 2D cell images, consequently losing crucial 3D spatial information. Alternatively, the 3D subcellular image acquisition has been developed based on relevant microscopy techniques, such as light-sheet microscopy [20], confocal microscopy [21], beam engineering [22], [23], and tomography [24], [25]. Nonetheless, these methods may necessitate compromises between 3D resolution, volumetric coverage, and throughput due to sequential acquisition, which may also lead to increased instrumental complexity and limited accessibility on commonly-used platforms such as epi-fluorescence microscopes. As a result, IFC-based platforms for single-cell investigations have yet to achieve the optimum balance in uncovering 3D subcellular details with high resolution, throughput, sensitivity, and uncomplicated instrumentation.

The advent of light-field microscopy (LFM), on the other hand, presents a particularly appealing solution for capturing fast-moving single-cell specimens. In essence, LFM can concurrently record the spatio-angular information of light, enabling computational reconstruction of the volume of a biological sample using just a single camera frame [26-36]. Recent advancements in Fourier LFM (also known as extended LFM) have further improved the image quality and computational efficiency [37-40], facilitating 3D subcellular, millisecond spatiotemporal studies across various biological systems, such as the functional brain [38], [41], organoids [42], and single-cell specimens [43], [44]. In comparison to other 3D techniques, the light-field approach promises single-shot, scanning-free 3D acquisition and instrumentally simple operation on epi-fluorescence platforms, both of which are desirable features for cytometric imaging.

The study developed a light-field flow cytometer (LFC), an IFC system designed for 3D volumetric, high-throughput, and multiparametric analysis of single-cell populations. The LFC system incorporates a high-resolution light-field optofluidic platform, hydrodynamic focusing, and stroboscopic illumination, offering a near-diffraction-limited and multi-color resolution of various 3D subcellular morphologies across all three dimensions at high speeds. The study demonstrated the system by examining and quantifying a range of phantoms and biological morphologies, functions, and heterogeneities, including peroxisomes and mitochondria in cultured cells, morphological characterizations of isolated cells from mice and humans, apoptotic alterations in staurosporine-treated Jurkat cells, and the expression of tdTomato following Cre mRNA delivery in mice. The study expect LFC, as an accessible and compatible cytometric imaging technique, to advance cell biology and translational research.

Discussion #2. In conclusion, the exemplary LFC system can enhance cell analysis by enabling high-sensitivity, 3D volumetric, and multiparametric data acquisition, allowing for the comprehensive examination of subcellular morphology, behavior, and interactions within their native 3D contexts. The exemplary LFC system can feature low instrumental complexity, making it compatible with commonly used epi-fluorescence microscopes and microfluidic devices. The Fourier light-field approach offers flexible scalability to accommodate various acquisition requirements while retaining its 3D and single-shot capabilities. In addition, it permits using lower magnification objective lenses—commonly found in conventional IFC instruments—to address various sample sizes or fluidic dimensions and achieve an enhanced throughput [14]. Specifically, LFC combines the 100× objective lens with individual microlenses, formulating an effective magnification of 42.5× that enhances the throughput over a conventional 100× system and restores the near-diffraction-limited resolution through computational synthesis. This combinatorial strategy alleviates the resolution-throughput tradeoff for IFC while retaining the unique snapshot 3D ability of light-field imaging. The functionality of the LFC system, such as the depth of focus and 3D resolution, can be further extended with various optical and computational frameworks [35], [61-65]. In particular, deep learning has evolved as a powerful approach to IFC systems [18], [66], [67], transforming a wide range of areas such as image processing, statistical analysis, and image-guided automation. In this context, deep neural networks present a viable alternative to traditional deconvolution algorithms, accelerating the generation of high-quality 3D reconstructions by a factor of at least two orders of magnitude. Such computational efficiency holds critical implications for leveraging LFC in the cytometric analysis of large cellular populations. The approach presents great potential for broad applicability in fundamental and translational research, with full integration possibilities including single-cell genomics [68], microscopy-based screening and diagnosis [69], [70], and image-enabled sorting [17], [19]. The LFC system can be seen as a paradigm for a diverse array of cytometric imaging applications in fields spanning biology, pharmacology, and medical diagnostics.

### CONCLUSION

Computer-executable instructions, such as program modules, being executed by a computer may be used. Generally, program modules include routines, programs, objects, components, data structures, etc., that perform particular tasks or implement particular abstract data types. In its most basic configuration, the controller includes at least one processing unit and memory. Depending on the exact configuration and type of computing device, memory may be volatile (such as random-access memory (RAM)), non-volatile (such as read-only memory (ROM), flash memory, etc.), or some combination of the two. The controller may have additional features/functionality.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Machine Learning. In addition to the deep neural network described herein, the analysis system can be implemented using one or more artificial intelligence and machine learning operations. The term “artificial intelligence” can include any technique that enables one or more computing devices or comping systems (i.e., a machine) to mimic human intelligence. Artificial intelligence (AI) includes but is not limited to knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders and embeddings. The term “deep learning” is defined herein to be a subset of machine learning that enables a machine to automatically discover representations needed for feature detection, prediction, classification, etc., using layers of processing. Deep learning techniques include but are not limited to artificial neural networks or multilayer perceptron (MLP).

Machine learning models include supervised, semi-supervised, and unsupervised learning models. In a supervised learning model, the model learns a function that maps an input (also known as feature or features) to an output (also known as target) during training with a labeled data set (or dataset). In an unsupervised learning model, the algorithm discovers patterns among data. In a semi-supervised model, the model learns a function that maps an input (also known as a feature or features) to an output (also known as a target) during training with both labeled and unlabeled data.

Neural Networks. An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers, such as an input layer, an output layer, and optionally one or more hidden layers with different activation functions. An ANN having hidden layers can be referred to as a deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanh, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include but are not limited to backpropagation. It should be understood that an artificial neural network is provided only as an example machine learning model. This disclosure contemplates that the machine learning model can be any supervised learning model, semi-supervised learning model, or unsupervised learning model. Optionally, the machine learning model is a deep learning model. Machine learning models are known in the art and are therefore not described in further detail herein.

A convolutional neural network (CNN) is a type of deep neural network that has been applied, for example, to image analysis applications. Unlike traditional neural networks, each layer in a CNN has a plurality of nodes arranged in three dimensions (width, height, depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by downsampling). A fully-connected layer includes neurons, where each neuron is connected to all of the neurons in the previous layer. The layers are stacked similarly to traditional neural networks. GCNNs are CNNs that have been adapted to work on structured datasets such as graphs.

Other Supervised Learning Models. A logistic regression (LR) classifier is a supervised classification model that uses the logistic function to predict the probability of a target, which can be used for classification. LR classifiers are trained with a data set (also referred to herein as a “dataset”) to maximize or minimize an objective function, for example, a measure of the LR classifier's performance (e.g., an error such as L1 or L2 loss), during training. This disclosure contemplates that any algorithm that finds the minimum of the cost function can be used. LR classifiers are known in the art and are therefore not described in further detail herein.

An Naïve Bayes' (NB) classifier is a supervised classification model that is based on Bayes' Theorem, which assumes independence among features (i.e., the presence of one feature in a class is unrelated to the presence of any other features). NB classifiers are trained with a data set by computing the conditional probability distribution of each feature given a label and applying Bayes' Theorem to compute the conditional probability distribution of a label given an observation. NB classifiers are known in the art and are therefore not described in further detail herein.

A k-NN classifier is an unsupervised classification model that classifies new data points based on similarity measures (e.g., distance functions). The k-NN classifiers are trained with a data set (also referred to herein as a “dataset”) to maximize or minimize a measure of the k-NN classifier's performance during training. This disclosure contemplates any algorithm that finds the maximum or minimum. The k-NN classifiers are known in the art and are therefore not described in further detail herein.

A majority voting ensemble is a meta-classifier that combines a plurality of machine learning classifiers for classification via majority voting. In other words, the majority voting ensemble's final prediction (e.g., class label) is the one predicted most frequently by the member classification models. The majority voting ensembles are known in the art and are therefore not described in further detail herein.

Although exemplary implementations may refer to utilizing aspects of the presently disclosed subject matter in the context of one or more stand-alone computer systems, the subject matter is not so limited but rather may be implemented in connection with any computing environment, such as a network or distributed computing environment. Still further, aspects of the presently disclosed subject matter may be implemented in or across a plurality of processing chips or devices, and storage may similarly be implemented across a plurality of devices. Such devices might include personal computers, network servers, handheld devices, and wearable devices, for example.

Although example embodiments of the present disclosure are explained in some instances in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an,” and “the” include plural referents unless the context clearly dictates otherwise. Ranges may be expressed herein as from “about” or “5 approximately” one particular value and/or to “about” or “approximately” another particular value. When such a range is expressed, other exemplary embodiments include from the one particular value and/or to the other particular value.

By “comprising” or “containing” or “including” is meant that at least the name compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5).

Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

The following patents, applications and publications as listed below and throughout this document are hereby incorporated by reference in their entirety herein.

### REFERENCE LIST #1

[1] Han, Y., Gu, Y., Zhang, A. C. & Lo, Y. H. Review: imaging technologies for flow cytometry. Lab Chip 16, 4639-4647 (2016).
[2] Stavrakis, S., Holzner, G., Choo, J. & deMello, A. High-throughput microfluidic imaging flow cytometry. Curr Opin Biotechnol 55, 36-43 (2019).
[3] Rees, P., Summers, H. D., Filby, A., Carpenter, A. E. & Doan, M. Imaging flow cytometry. Nature Reviews Methods Primers 2, 86 (2022).
[4] Doan, M. et al. Diagnostic Potential of Imaging Flow Cytometry. Trends Biotechnol 36, 649-652 (2018).
[5] Barteneva, N. S. et al. Imaging flow cytometry: methods and protocols. (Springer, 2016).
[6] Woud, W. W. et al. An imaging flow cytometry-based methodology for the analysis of single extracellular vesicles in unprocessed human plasma. Commun Biol 5, 633 (2022).
[7] Cossarizza, A. et al. Guidelines for the use of flow cytometry and cell sorting in immunological studies (third edition). Eur J Immunol 51, 2708-3145 (2021).
[8] Mastoridis, S. et al. Multiparametric Analysis of Circulating Exosomes and Other Small Extracellular Vesicles by Advanced Imaging Flow Cytometry. Front Immunol 9, 1583 (2018).
[9] Power, A. L. et al. The Application of Imaging Flow Cytometry for Characterisation and Quantification of Bacterial Phenotypes. Front Cell Infect Microbiol 11, 716592 (2021).
[10] More, T. A. et al. Applications of imaging flow cytometry in the diagnostic assessment of red cell membrane disorders. Cytometry B Clin Cytom 98, 238-249 (2020).
[11] 11. Grimwade, L. F., Fuller, K. A. & Erber, W. N. Applications of imaging flow cytometry in the diagnostic assessment of acute leukaemia. Methods 112, 39-45 (2017).
[12] Ahn, J. C. et al. Detection of Circulating Tumor Cells and Their Implications as a Biomarker for Diagnosis, Prognostication, and Therapeutic Monitoring in Hepatocellular Carcinoma. Hepatology 73, 422-436 (2021).
[13] Rane, A. S., Rutkauskaite, J., deMello, A. & Stavrakis, S. High-throughput multi-parametric imaging flow cytometry. Chem 3, 588-602 (2017).
[14] Holzner, G. et al. High-throughput multiparametric imaging flow cytometry: toward diffraction-limited sub-cellular detection and monitoring of sub-cellular processes. Cell Rep 34, 108824 (2021).
[15] Mikami, H. et al. Virtual-freezing fluorescence imaging flow cytometry. Nat Commun 11, 1162 (2020).
[16] Diebold, E. D., Buckley, B. W., Gossett, D. R. & Jalali, B. Digitally synthesized beat frequency multiplexing for sub-millisecond fluorescence microscopy. Nature Photonics 7, 806-810 (2013).
[17] Nitta, N. et al. Intelligent Image-Activated Cell Sorting. Cell 175, 266-276 e213 (2018).
[18] Siu, D. M. D. et al. Optofluidic imaging meets deep learning: from merging to emerging. Lab Chip 23, 1011-1033 (2023).
[19] Schraivogel, D. et al. High-speed fluorescence image-enabled cell sorting. Science 375, 315-320 (2022).
[20] Gualda, E. J., Pereira, H., Martins, G. G., Gardner, R. & Moreno, N. Three-dimensional imaging flow cytometry through light-sheet fluorescence microscopy. Cytometry A 91, 144-151 (2017).
[21] Quint, S. et al. 3D tomography of cells in micro-channels. Applied Physics Letters 111, 103701 (2017).
[22] Weiss, L. E. et al. Three-dimensional localization microscopy in live flowing cells. Nat Nanotechnol 15, 500-506 (2020).
[23] Lai, Q. T. K. et al. High-speed laser-scanning biological microscopy using FACED. Nat Protoc 16, 4227-4264 (2021).
[24] Merola, F. et al. Tomographic flow cytometry by digital holography. Light Sci Appl 6, e16241 (2017).
[25] Kleiber, A., Kraus, D., Henkel, T. & Fritzsche, W. Review: tomographic imaging flow cytometry. Lab Chip 21, 3655-3666 (2021).
[26] Levoy, M., Ng, R., Adams, A., Footer, M. & Horowitz, M. in ACM SIGGRAPH 2006 Papers, Vol. 25, Edn. 3 924-934 (2006).
[27] Levoy, M., Zhang, Z. & McDowall, I. Recording and controlling the 4D light field in a microscope using microlens arrays. Journal of microscopy 235, 144-162 (2009).
[28] Broxton, M. et al. Wave optics theory and 3-D deconvolution for the light field microscope. Opt Express 21, 25418-25439 (2013).
[29] Prevedel, R. et al. Simultaneous whole-animal 3D imaging of neuronal activity using light-field microscopy. Nat Methods 11, 727-730 (2014).
[30] Pégard, N. C. et al. Compressive light-field microscopy for 3D neural activity recording. Optica 3, 517-524 (2016).
[31] Nobauer, T. et al. Video rate volumetric Ca (2+) imaging across cortex using seeded iterative demixing(SID) microscopy. Nat Methods 14, 811-818 (2017).
[32] Fan, J. et al. Video-rate imaging of biological dynamics at centimetre scale and micrometre resolution. Nature Photonics 13, 809-816 (2019).
[33] Wagner, N. et al. Instantaneous isotropic volumetric imaging of fast biological processes. Nat Methods 16, 497-500 (2019).
[34] Li, H. et al. Fast, volumetric live-cell imaging using high-resolution light-field microscopy. Biomed. Opt. Express 10, 29-49 (2019).
[35] Wu, J. et al. Iterative tomography with digital adaptive optics permits hour-long intravital observation of 3D subcellular dynamics at millisecond scale. Cell 184, 3318-3332 e3317 (2021).
[36] Javidi, B. et al. Roadmap on 3D integral imaging: sensing, processing, and display. Opt Express 28, 32266-32293 (2020).
[37] Llavador, A., Sola-Pikabea, J., Saavedra, G., Javidi, B. & Martinez-Corral, M. Resolution improvements in integral microscopy with Fourier plane recording. Opt Express 24, 20792-20798 (2016).
[38] Cong, L. et al. Rapid whole brain imaging of neural activity in freely behaving larval zebrafish (Danio rerio). Elife 6, e28158 (2017).
[39] Scrofani, G. et al. FIMic: design for ultimate 3D-integral microscopy of in-vivo biological samples. Biomed. Opt. Express 9, 335-346 (2018).
[40] Guo, C., Liu, W., Hua, X., Li, H. & Jia, S. Fourier light-field microscopy. Opt Express 27, 25573-25594 (2019).
[41] Zhang, Z. et al. Imaging volumetric dynamics at high speed in mouse and zebrafish brain with confocal light field microscopy. Nat Biotechnol 39, 74-83 (2021).
[42] Liu, W., Kim, G. R., Takayama, S. & Jia, S. Fourier light-field imaging of human organoids with a hybrid point-spread function. Biosens Bioelectron 208, 114201 (2022).
[43] Hua, X., Liu, W. & Jia, S. High-resolution Fourier light-field microscopy for volumetric multi-color live-cell imaging. Optica 8, 614-620 (2021).
[44] Sims, R. R. et al. Single molecule light field microscopy. Optica 7, 1065-1072 (2020).
[45] Golden, J. P., Justin, G. A., Nasir, M. & Ligler, F. S. Hydrodynamic focusing—a versatile tool. Anal Bioanal Chem 402, 325-335 (2012).
[46] Mandracchia, B. et al. Fast and accurate sCMOS noise correction for fluorescence microscopy. Nat Commun 11, 94 (2020).
[47] Paie, P., Bragheri, F., Bassi, A. & Osellame, R. Selective plane illumination microscopy on a chip. Lab Chip 16, 1556-1560 (2016).
[48] Fan, Y. J. et al. Microfluidic channel integrated with a lattice lightsheet microscopic system for continuous cell imaging. Lab Chip 21, 344-354 (2021).
[49] Sala, F. et al. High-throughput 3D imaging of single cells with light-sheet fluorescence microscopy on chip. Biomed. Opt. Express 11, 4397-4407 (2020).
[50] Huang, H. C. et al. Three-dimensional nucleus-to-cytoplasm ratios provide better discrimination of normal and lung adenocarcinoma cells than in two dimensions. J Biomed Opt 24, 1-4 (2019).
[51] Hematology and Clinical Microscopy Glossary. College of American Pathologists (2023).
[52] Lockshin, R. A. & Zakeri, Z. Cell death in health and disease. J Cell Mol Med 11, 1214-1224 (2007).
[53] Gibellini, L. & Moro, L. Programmed Cell Death in Health and Disease. Cells 10, 1765 (2021).
[54] Ziegler, U. & Groscurth, P. Morphological features of cell death. News Physiol Sci 19, 124-128 (2004).
[55] Belmokhtar, C. A., Hillion, J. & Segal-Bendirdjian, E. Staurosporine induces apoptosis through both caspase-dependent and caspase-independent mechanisms. Oncogene 20, 3354-3362 (2001).
[56] Johnson, V. L., Ko, S. C., Holmstrom, T. H., Eriksson, J. E. & Chow, S. C. Effector caspases are dispensable for the early nuclear morphological changes during chemical-induced apoptosis. J Cell Sci 113 (Pt 17), 2941-2953 (2000).
[57] Paunovska, K., Loughrey, D. & Dahlman, J. E. Drug delivery systems for RNA therapeutics. Nat Rev Genet 23, 265-280 (2022).
[58] Paunovska, K. et al. Nanoparticles Containing Oxidized Cholesterol Deliver mRNA to the Liver Microenvironment at Clinically Relevant Doses. Adv Mater 31, e1807748 (2019).
[59] Dahlman, J. E. et al. In vivo endothelial siRNA delivery using polymeric nanoparticles with low molecular weight. Nat Nanotechnol 9, 648-655 (2014).
[60] Adams, D. et al. Patisiran, an RNAi Therapeutic, for Hereditary Transthyretin Amyloidosis. N Engl J Med 379, 11-21 (2018).
[61] Lu, Z. et al. Virtual-scanning light-field microscopy for robust snapshot high-resolution volumetric imaging. Nature Methods (2023).
[62] Wagner, N. et al. Deep learning-enhanced light-field imaging with continuous validation. Nature Methods 18, 557-563 (2021).
[63] Han, K. et al. 3D super-resolution live-cell imaging with radial symmetry and Fourier light-field microscopy. Biomed. Opt. Express 13, 5574-5584 (2022).
[64] Mertz, J. Strategies for volumetric imaging with a fluorescence microscope. Optica 6, 1261-1268 (2019).
[65] Laine, R. F. et al. High-fidelity 3D live-cell nanoscopy through data-driven enhanced super-resolution radial fluctuation. Nat Methods (2023).
[66] Huang, K. et al. Deep imaging flow cytometry. Lab Chip 22, 876-889 (2022).
[67] Luo, S. B. et al. Machine-Learning-Assisted Intelligent Imaging Flow Cytometry: A Review. Advanced Intelligent Systems 3, 2100073 (2021).
[68] Haase, C. et al. Image-seq: spatially resolved single-cell sequencing guided by in situ and in vivo imaging. Nat Methods 19, 1622-1633 (2022).
[69] Gérard, A. et al. High-throughput single-cell activity-based screening and sequencing of antibodies using droplet microfluidics. Nature Biotechnology 38, 715-721 (2020).
[70] Boutros, M., Heigwer, F. & Laufer, C. Microscopy-Based High-Content Screening. Cell 163, 1314-1325 (2015).

### REFERENCE LIST #2

[1′] Mandracchia, B. et al. Fast and accurate sCMOS noise correction for fluorescence microscopy. Nature Communications 11, 94-94 (2020).
[2′] Sternberg, S. Biomedical Image Processing. IEEE Computer 16, 22-34 (1983).
[3′] Lee, G.-B., Chang, C.-C., Huang, S.-B. & Yang, R.-J. The hydrodynamic focusing effect inside rectangular microchannels. Journal of Micromechanics and Microengineering 16, 1024 (2006).
[4′] Golden, J. P., Justin, G. A., Nasir, M. & Ligler, F. S. Hydrodynamic focusing—a versatile tool. Analytical and Bioanalytical Chemistry 402, 325-335 (2012).
[5′] Han, K. et al. 3D super-resolution live-cell imaging with radial symmetry and Fourier light-field microscopy. Biomed. Opt. Express 13, 5574-5584 (2022).
[6′] Hua, X., Liu, W. & Jia, S. High-resolution Fourier light-field microscopy for volumetric multicolor live-cell imaging. Optica 8, 614-620 (2021).
[7′] Liu, W., Kim, G. R., Takayama, S. & Jia, S. Fourier light-field imaging of human organoids with a hybrid point-spread function. Biosens Bioelectron 208, 114201 (2022).
[8′] Ling, Z., Han, K., Liu, W., Hua, X. & Jia, S. Volumetric live-cell autofluorescence imaging using Fourier light-field microscopy. Biomedical Optics Express 14, 4237 (2023).
[9′] Rane, A. S., Rutkauskaite, J., deMello, A. & Stavrakis, S. High-throughput multi-parametric imaging flow cytometry. Chem 3, 588-602 (2017).
[10′] Holzner, G. et al. High-throughput multiparametric imaging flow cytometry: toward diffractionlimited sub-cellular detection and monitoring of sub-cellular processes. Cell Rep 34, 108824 (2021).
[11′] Mikami, H. et al. Virtual-freezing fluorescence imaging flow cytometry. Nat Commun 11, 1162 (2020).
[12′] Diebold, E. D., Buckley, B. W., Gossett, D. R. & Jalali, B. Digitally synthesized beat frequency multiplexing for sub-millisecond fluorescence microscopy. Nature Photonics 7, 806-810 (2013).
[13′] Lu, Z. et al. Virtual-scanning light-field microscopy for robust snapshot high-resolution volumetric imaging. Nature Methods 20, 735-746 (2023).
[14′] Wagner, N. et al. Deep learning-enhanced light-field imaging with continuous validation. Nature Methods 18, 557-563 (2021).
[15′] Wu, J. et al. Iterative tomography with digital adaptive optics permits hour-long intravital observation of 3D subcellular dynamics at millisecond scale. Cell 184, 3318-3332 e3317 (2021).
[16′] Guo, C., Liu, W., Hua, X., Li, H. & Jia, S. Fourier light-field microscopy. Optics Express 27, 25573-25594 (2019).
[17′] Gérard, A. et al. High-throughput single-cell activity-based screening and sequencing of antibodies using droplet microfluidics. Nature Biotechnology 38, 715-721 (2020).
[18′] Boutros, M., Heigwer, F. & Laufer, C. Microscopy-Based High-Content Screening. Cell 163, 1314-1325 (2015).
[19′] AbuZineh, K. et al. Microfluidics-based super-resolution microscopy enables nanoscopic characterization of blood stem cell rolling. Sci Adv 4, eaat5304 (2018).
[20′] Almada, P. et al. Automating multimodal microscopy with NanoJ-Fluidics. Nat Commun 10, 1223 (2019).
[21′] Mandracchia, B., Son, J. & Jia, S. Super-resolution optofluidic scanning microscopy. Lab on a Chip (2021).
[22′] Almada, P. et al. Automating multimodal microscopy with NanoJ-Fluidics. Nature Communications 10, 1223-1223 (2019).
[23′] Arthur, D. & Vassilvitskii, S. in Proceedings of the eighteenth annual ACM-SIAM symposium on Discrete algorithms 1027-1035 (2007).
[24′] Quint, S. et al. 3D tomography of cells in micro-channels. Applied Physics Letters 111, 103701 (2017).
[25′] Fan, Y.-J. et al. Microfluidic channel integrated with a lattice lightsheet microscopic system for continuous cell imaging. Lab on a Chip 21, 344-354 (2021).
[26′] Ugawa, M. & Ota, S. High-speed 3D imaging flow cytometry with optofluidic spatial transformation. Biomed. Opt. Express 13, 3647-3656 (2022).
[27′] Kleiber, A. et al. 3-Step flow focusing enables multidirectional imaging of bioparticles for imaging flow cytometry. Lab on a chip 20, 1676-1686 (2020).
[28′] Kumar, P., Joshi, P., Basumatary, J. & Mondal, P. P. Light sheet based volume flow cytometry (VFC) for rapid volume reconstruction and parameter estimation on the go. Scientific reports 12, 1-15 (2022).
[29′] Han, Y. et al. Cameraless high-throughput three-dimensional imaging flow cytometry. Optica 6, 1297-1304 (2019).
[30′] Zhang, Z. et al. A high-throughput technique to map cell images to cell positions using a 3D imaging flow cytometer. Proc Natl Acad Sci USA 119, e2118068119 (2022).
[31′] Miura, T. et al. On-chip light-sheet fluorescence imaging flow cytometry at a high flow speed of 1 m/s. Biomedical optics express 9, 3424-3433 (2018).
[32′] Nitta, N. et al. Intelligent Image-Activated Cell Sorting. Cell 175, 266-276 e213 (2018).
[33′] Holzner, G. et al. High-throughput multiparametric imaging flow cytometry: toward diffractionlimited sub-cellular detection and monitoring of sub-cellular processes. Cell Reports (2021).
[34′] Isozaki, A. et al. Intelligent image-activated cell sorting 2.0. Lab Chip 20, 2263-2273 (2020).
[35′] Munoz, H. E. et al. Single-Cell Analysis of Morphological and Metabolic Heterogeneity in Euglena gracilis by Fluorescence-Imaging Flow Cytometry. Anal Chem 90, 11280-11289 (2018).
[36′] Gong, Y. et al. Flow Cytometry with Anti-Diffraction Light Sheet (ADLS) by Spatial Light Modulation. Micromachines (Basel) 14 (2023).
[37′] Ota, S. et al. Ghost cytometry. Science 360, 1246-1251 (2018).
[38′] Schraivogel, D. et al. High-speed fluorescence image-enabled cell sorting. Science 375, 315-320 (2022).
[39′] George, T. C. et al. Distinguishing modes of cell death using the ImageStream® multispectral imaging flow cytometer. Cytometry Part A: the journal of the International Society for Analytical Cytology 59, 237-245 (2004).
[40′] Goda, K. et al. High-throughput single-microparticle imaging flow analyzer. Proc Natl Acad Sci USA 109, 11630-11635 (2012).
[41′] Rees, P., Summers, H. D., Filby, A., Carpenter, A. E. & Doan, M. Imaging flow cytometry. Nature Reviews Methods Primers 2, 86 (2022).
[42′] Sullivan, C. & Kaszynski, A. PyVista: 3D plotting and mesh analysis through a streamlined interface for the Visualization Toolkit (VTK). Journal of Open Source Software 4, 1450 (2019).
[43′] Royer, L. A. et al. ClearVolume: open-source live 3D visualization for light-sheet microscopy. Nature Methods 12, 480-481 (2015).
[44′] Ollion, J., Cochennec, J., Loll, F., Escudé, C. & Boudier, T. TANGO: a generic tool for highthroughput 3D image analysis for studying nuclear organization. Bioinformatics 29, 1840-1841 (2013).
[45′] Li, X. et al. Three-dimensional structured illumination microscopy with enhanced axial resolution. Nat Biotechnol 41, 1307-1319 (2023).
[46′] Hua, X., Han, K., Mandracchia, B. et al. Light-field flow cytometry for high-resolution, volumetric and multiparametric 3D single-cell analysis. Nat Commun 15, 1975 (2024).

1. A system for capturing cytometric images of a plurality of cells or particles in a moving fluidic sample, the system comprising:
a cytometric microfluidic chip having one or more channels, including a first channel for flow and imaging of the plurality of cells or particles;
one or more laser sources, including a first laser device configured to project a laser beam of the first laser device on the fluidic sample;
an optical assembly optically connected to the one or more laser sources, the optical assembly being configured to (i) emit the laser beam on the fluidic sample, (ii) receive fluorescence rays emitted from the fluidic sample in response to the fluidic sample being projected with the emitted laser beam, and (iii) generate wide-field and light-field images of the fluidic sample from the received fluorescence rays;
a microlens array coupled to the optical assembly, the microlens array having a plurality of microlens elements configured to partition the wide-field and light-field images into a plurality of elemental images, each having a high field of view and depth of focus; and
a sensor configured to capture the plurality of the elemental images at a back focal plane of the microlens array,
wherein the plurality of elemental images are used, via a reconstruction algorithm, to generate a 3D cytometric high-resolution, wide-field image or video of the plurality of cells or particles concurrently captured in a single view and at different depths.

2. The system of claim 1 further comprising:
a stroboscopic-illumination controlling module (SICM) coupled between the one or more laser sources and the optical assembly, the SICM being configured to:
modulate the laser beam; and
project the modulated laser beam on the fluidic sample to excite the plurality of cells or particles.

3. The system of claim 1, wherein the one or more channels further includes two secondary channels.

4. The system of claim 3, wherein the first channel contains the fluidic sample and the two secondary channels contain a salt solution, wherein the salt solution in the two secondary channels is injected into the fluidic sample in the first channel to facilitate focused-flowing of the fluidic sample within field of view of the system.

5. The system of claim 1, wherein the one or more laser sources further include a second laser device, the system further comprising a second optical assembly to combine (i) the first laser beam and (ii) a second laser beam from the second laser device to generate the laser beam to be emitted through the optical assembly.

6. The system of claim 1, wherein the microlens elements of the microlens array are formed in the microlens array in a flat configuration.

7. The system of claim 1 further comprising:
an image processing unit having a processor and a memory having instructions stored thereon to generate the 3D cytometric high-resolution, wide-field image or video of the plurality of cells or particles, wherein execution of the instructions by the processor causes the processor to:
receive the plurality of elemental images;
remove blank images or images with non-specific fluorescence from the received images to generate a set of reconstructable images;
remove outside-field-of-view regions from the set of reconstructable images; and
reconstruct the set of modified reconstructable images via a hybrid point-spread-function-based deconvolution operation to generate the 3D cytometric high-resolution, wide-field image or video of the plurality of cells or particles.

8. The system of claim 5, wherein the first laser beam and the second laser beam have different wavelengths of different colors.

9. The system of claim 5, wherein the first laser beam and the second laser beam have same wavelengths.

11. A method comprising:
generating a laser beam from a laser source;
capturing cytometric images of a plurality of cells or particles in a moving fluidic sample by:
providing a cytometric microfluidic chip having one or more channels, including a first channel for flow and imaging of the plurality of cells or particles;
emitting the laser beam on the fluidic sample;
receiving fluorescence rays emitted from the fluidic sample in response to the fluidic sample being projected with the emitted laser beam;
generating wide-field and light-field images of the fluidic sample from the received fluorescence rays;
partitioning, via a microlens array, the wide-field and light-field images into a plurality of elemental images, each having a high field of view and depth of focus;
capturing, via a sensor, the plurality of the elemental images at a back focal plane of the microlens array;
generating, via a reconstruction algorithm, a 3D cytometric high-resolution, wide-field image or video of the plurality of cells or particles concurrently captured in a single view and at different depths using the plurality of elemental images.

12. The method of claim 11 further comprising:
prior to emitting the laser beam on the fluidic sample:
modulating the laser beam using a SICM; and
projecting the modulated laser beam on the fluidic sample to excite the plurality of cells or particles.

13. The method of claim 11 further comprising:
receiving the plurality of elemental images;
removing blank images or images with non-specific fluorescence from the received images to generate a set of reconstructable images;
removing outside-field-of-view regions from the set of reconstructable images; and
reconstructing the set of modified reconstructable images via a hybrid point-spread-function-based deconvolution operation to generate the 3D cytometric high-resolution, wide-field image or video of the plurality of cells or particles.

14. The method of claim 11, wherein the one or more channels further includes two secondary channels.

15. The method of claim 14, wherein the first channel contains the fluidic sample and the two secondary channels contain a salt solution, wherein the salt solution in the two secondary channels is injected into the fluidic sample in the first channel to facilitate focused-flowing of the fluidic sample.

16. A system for capturing cytometric images of a plurality of cells or particles in a moving fluidic sample, the system comprising:
one or more laser sources, including a first laser device configured to project a laser beam of the first laser device on the fluidic sample, wherein the fluidic sample is contained in a cytometric microfluidic chip having one or more channels, including a first channel for flow and imaging of the plurality of cells or particles;
an optical assembly optically connected to the one or more laser sources, the optical assembly being configured to (i) emit the laser beam on the fluidic sample, (ii) receive fluorescence rays emitted from the fluidic sample in response to the fluidic sample being projected with the emitted laser beam, and (iii) generate wide-field and light-field images of the fluidic sample from the received fluorescence rays;
a microlens array coupled to the optical assembly, the microlens array having a plurality of microlens elements configured to partition the wide-field and light-field images into a plurality of elemental images, each having a high field of view and depth of focus; and
a sensor configured to capture the plurality of the elemental images at a back focal plane of the microlens array,
wherein the plurality of elemental images are used, via a reconstruction algorithm, to generate a 3D cytometric high-resolution, wide-field image or video of the plurality of cells or particles concurrently captured in a single view and at different depths.

17. The system of claim 16 further comprising:
a stroboscopic-illumination controlling module (SICM) coupled between the one or more laser sources and the optical assembly, the SICM being configured to:
modulate the laser beam; and
project the modulated laser beam on the fluidic sample to excite the plurality of cells or particles.

18. The system of claim 16, wherein the one or more channels further includes two secondary channels.

19. The system of claim 18, wherein the first channel contains the fluidic sample and the two secondary channels contain a salt solution, wherein the salt solution in the two secondary channels is injected into the fluidic sample in the first channel to facilitate focused-flowing of the fluidic sample within field of view of the system.

20. (canceled)
